(19) United States
(12) Patent Application Publication
(10) Pub. No.: US 2017/0039077 A1
(43) Pub. Date: Feb. 9, 2017

(54) INFORMATION PROCESSING SYSTEM AND INFORMATION PROCESSING METHOD

(71) Applicant: Hajime KUBOTA, Kanagawa (JP)

(72) Inventor: Hajime KUBOTA, Kanagawa (JP)

(21) Appl. No.: 15/225,934

(22) Filed: Aug. 2, 2016

(30) Foreign Application Priority Data
Aug. 4, 2015 (JP) 2015-154540

(51) Int. Cl. G06F 9/445; G06F 13/20

(52) U.S. Cl. CPC G06F 9/44505; G06F 13/20

(57) ABSTRACT

A system includes: a first unit to accept operational input; and a second unit to operate in response to the operational input. The first unit includes: an accepting unit to accept an input or output request for setting information on an application operating in the first unit or the second unit; an execution determining unit to acquire an operational status of the second unit and, based on the acquired operational status, determine whether the second unit can currently execute input or output processing corresponding to the input or output request; and a communication unit to transmit the input or output request for the setting information to the second unit depending on a result of the determination. The second unit includes a setting managing unit to, in response to the input or output request received from the communication unit, cause input or output processing for the setting information to be executed.

### CROSS-REFERENCE TO RELATED APPLICATIONS

The present application claims priority under 35 U.S.C. §119 to Japanese Patent Application No. 2015-154540, filed Aug. 4, 2015. The contents of which are incorporated herein by reference in their entirety.

### BACKGROUND OF THE INVENTION

1. Field of the Invention

The present invention relates to an information processing system and an information processing method.

2. Description of the Related Art

There has been an image forming apparatus including not only a main body unit to provide conventional functions of an image forming apparatus, but also an operation unit, which includes an operating system (OS) and applications that run on the OS and implement various functions, to provide various functions utilizing the conventional functions. An image forming apparatus has the function of outputting (exporting) setting information (setting values) to various functions and the function of inputting (importing) setting information to various functions. These functions are used in such situations as where it is necessary to collectively bring a plurality of apparatus to the same settings and where it is necessary to bring an apparatus to the same settings as another apparatus replaced with the foregoing one.

Japanese Unexamined Patent Application Publication No. 2012-226662 discloses a technique configured to: compare one piece and another piece of machine identification information with each other that are one acquired from setting information input from an apparatus connected and one belonging to an apparatus to which setting information is imported, respectively; determine a level at which setting information is imported; and import information in accordance with the determined level.

However, an image forming apparatus in Japanese Unexamined Patent Application Publication No. 2012-226662 is not enabled to execute input/output processing for setting information when the main body unit is temporarily unusable for such a reason as that it is in a power saving mode or that it is executing processing for which settings are not changeable.

### SUMMARY OF THE INVENTION

Exemplary embodiments of the present invention, there is provided an information processing system comprising: a first unit configured to accept operational input; and a second unit configured to operate in response to the operational input. In the information processing system, the first unit includes: an accepting unit configured to accept an input or output request for setting information on an application that operates in the first unit or the second unit; an execution determining unit configured to acquire an operational status of the second unit and, based on the acquired operational status, determine whether the second unit is currently able to execute input or output processing corresponding to the input or output request received by the accepting unit; and a communication unit configured to transmit the input or output request for the setting information to the second unit depending on a result of the determination by the execution determining unit, and the second unit includes a setting managing unit configured to, in response to the input or output request received from the communication unit, cause input or output processing for the setting information to be executed.

Exemplary embodiments of the present invention also provide an information processing method to be executed in an information processing system that comprises a first unit configured to accept operational input and a second unit configured to operate in response to the operational input, the information processing method comprising: accepting an input or output request for setting information on an application that operates in the first unit or the second unit; based on an operational status of the second unit, determining whether the second unit is currently able to execute input or output processing corresponding to the input or output request received at the accepting; transmitting the input or output request for the setting information to the second unit depending on a result of the determining; and in response to the input or output request transmitted at the transmitting, causing input or output processing for the setting information to be executed.

Exemplary embodiments of the present invention also provide an information processing system comprising: a first unit that accepts operational input; and a second unit that operates in response to the operational input. In the information processing system, the first unit includes first circuitry configured to: accept an input or output request for setting information on an application that operates in the first unit or the second unit; acquire an operational status of the second unit and, based on the acquired operational status; determine whether the second unit is currently able to execute input or output processing corresponding to the input or output request accepted; and transmit the input or output request for the setting information to the second unit depending on a result of the determination by the execution determining unit, and the second unit includes second circuitry configured to cause input or output processing for the setting information to be executed, in response to the input or output request received from the communication unit.

### BRIEF DESCRIPTION OF THE DRAWINGS

FIG. 1 is a diagram illustrating an example of the hardware composition of a multifunction peripheral (MFP) in a first embodiment of the present invention;

FIG. 2 is a diagram illustrating exemplary functional blocks in the MFP in the first embodiment;

FIGS. 3A and 3B are diagrams illustrating exemplary sets of setting information that are processed by operation unit applications;

FIG. 4 is a diagram illustrating an exemplary set of setting information that is transmitted and received between an operation unit and a main body unit;

FIG. 5 is a diagram illustrating an exemplary set of setting information that is finally generated by a setting managing unit in the main body unit;

FIG. 6 is a flowchart applicable when an export request or import request from the outside is accepted;

FIG. 7 is a sequence illustrating an example of export processing in the first embodiment;

FIG. 8 is a diagram explaining flows of individual sets of information in export processing;

FIG. 9 is a sequence applicable when the main body unit is currently unable to immediately execute export processing;

FIG. 10 is a diagram explaining flows of individual sets of information in a case when the main body unit is currently unable to immediately execute export processing;

FIG. 11 is a sequence illustrating an example of import processing in the first embodiment;

FIG. 12 is a diagram explaining flows of individual sets of information in import processing;

FIG. 13 is a sequence applicable when the main body unit is currently unable to immediately execute import processing;

FIG. 14 is a diagram explaining flows of individual sets of information in a case when the main body unit is currently unable to immediately execute import processing;

FIG. 15 is a diagram illustrating exemplary functional blocks in an operation unit in a second embodiment of the present invention;

FIG. 16 is a diagram illustrating exemplary conditions for import reflection in the second embodiment;

FIG. 17 is a diagram illustrating conditions corresponding to the operational status of a main body unit for determining whether a target function is usable;

FIG. 18 is a flowchart illustrating import reflection processing in the second embodiment;

FIG. 19 is a flowchart applicable when a function in the main body unit is to be used;

FIG. 20 is a flowchart for the entire import processing in an operation unit and the main body unit; and

FIG. 21 is a flowchart for processing for providing a usable function.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, an and the are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

The following describes embodiments of an information processing system and an information processing method according to the present invention. The following describes examples in which a multifunction peripheral (MFP) having at least two functions from, for example, the copy function, the printer function, the scanner function, and the facsimile function is implemented as the information processing system. Other than an MFP, the present invention may be applied to image forming apparatuses such as a copier, a printer, a scanner apparatus, and a facsimile apparatus. Systems (apparatuses) to which the present invention can be applied are not limited to image forming apparatuses, and include any system (apparatus) that includes a main body unit and an operation unit.

### First Embodiment

Exemplary Hardware Composition of MFP

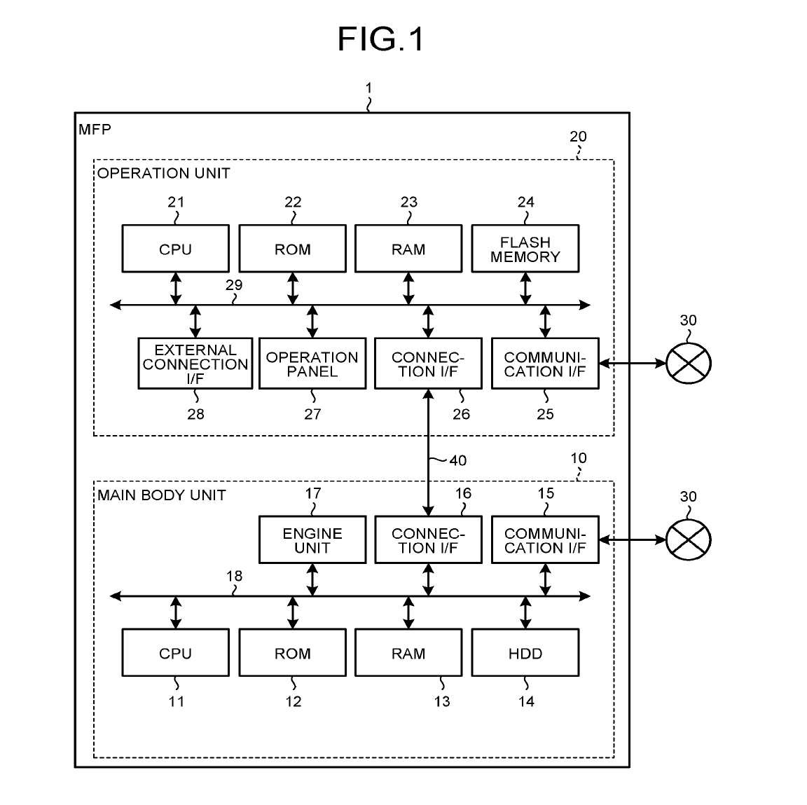

FIG. 1 is a diagram illustrating an example of the hardware composition of an MFP in a first embodiment. As illustrated in FIG. 1, an MFP 1 includes a main body unit 10 and an operation unit 20. The main body unit 10 implements various functions such as the copy function, the printer function, the scanner function, and the facsimile function. The operation unit 20 accepts information (operational input) corresponding to operations performed by a user. The meaning of “accepting operations performed by a user” includes accepting information (including a signal indicating coordinate values of a screen) input in response to operations performed by a user. Information input through the operation unit 20 is transmitted in the form of instructions or information to the main body unit 10, so that corresponding processing is executed on the part of the main body unit 10. In the MFP 1, the operation unit 20 is an example of the first unit, while the main body unit 10 is an example of the second unit.

The main body unit 10 and the operation unit 20 are connected to each other through a connection interface (I/F) 16, a dedicated communication path 40, and a connection I/F 26 so as to be able to communicate with each other. As the communication path 40, a path based on the universal serial bus (USB) standard for example can be used, but a wired or wireless path based on any standard may be used.

The main body unit 10 operates in accordance with operations accepted by the operation unit 20. The main body unit 10 is capable of communicating with an external apparatus such as a client personal computer (PC), and is also capable of operating in accordance with instructions (such as a printing instruction) received from the external apparatus.

The main body unit 10 illustrated in FIG. 1 includes a CPU 11, a read-only memory (ROM) 12, a random-access memory (RAM) 13, a hard disk drive (HDD) 14, a communication I/F 15, the connection I/F 16, and an engine unit 17. The CPU 11, the ROM 12, the RAM 13, the HDD 14, the communication I/F 15, the connection I/F 16, and the engine unit 17 are connected through a system bus 18.

The CPU 11 entirely controls the overall operation of the main body unit 10. The CPU 11 controls the overall operation of the entire main body unit 10 by executing computer programs (applications) stored in storages such as the ROM 12 and the HDD 14 while using the RAM 13 as a work area, thereby implementing the foregoing various functions such as the copy function, the scanner function, the facsimile function, and the printer function. Each of these functions is implemented when an application corresponding thereto is executed.

The communication I/F 15 is an interface for connection with a network 30. The connection I/F 16 is an interface for communicating with the operation unit 20 through the communication path 40.

The engine unit 17 is hardware for implementing functions such as the copy function, the scanner function, the facsimile function, and the printer function. For example, the engine unit 17 includes units such as a scanner (an image reading unit) to scan and read document images, a plotter (an image forming unit) to perform printing on sheet materials such as a sheet of paper, and a facsimile unit to perform facsimile communication. The engine unit 17 may include a piece of hardware that implements a particular option, such as a finisher to sort printed sheet materials or an automatic document feeder (ADF) to automatically feed documents.

The operation unit 20 illustrated in FIG. 1 includes a CPU 21, a ROM 22, a RAM 23, a flash memory 24, a communication I/F 25, the connection I/F 26, an operation panel 27, and an external connection I/F 28. The CPU 21, the ROM 22, the RAM 23, the flash memory 24, the communication I/F 25, the connection I/F 26, the operation panel 27, and the external connection I/F 28 are connected to one another through a system bus 29.

The CPU 21 entirely controls the overall operation of the operation unit 20. The CPU 21 controls the overall operation of the entire operation unit 20 by executing computer programs stored in storages such as the ROM 22 and the flash memory 24 while using the RAM 23 as a work area, thereby implementing various functions such as displaying information (an image) corresponding to input accepted from the user.

The communication I/F 25 is an interface for connection with a network 30. The connection I/F 26 is an interface for communicating with the main body unit 10 through the communication path 40.

The operation panel 27 accepts various kinds of input that correspond to operations performed by the user and displays thereon various kinds of information (such as information corresponding to an operation accepted, information indicating the operational status of the MFP 1, and information indicating conditions of settings). The operation panel 27 is constructed of, for example, a liquid crystal display device (LCD) equipped with a touch panel function but is not limited thereto, and may be constructed of an organic electro luminescent (EL) display device equipped with a touch panel function. In addition, the operation panel 27 may be provided with an operation part such as hardware keys and/or an indicating unit such as a lamp.

The external connection I/F 28 is an interface for connection with a device such as an integrated circuit (IC) card reader, for example.

Exemplary Functional Blocks of MFP

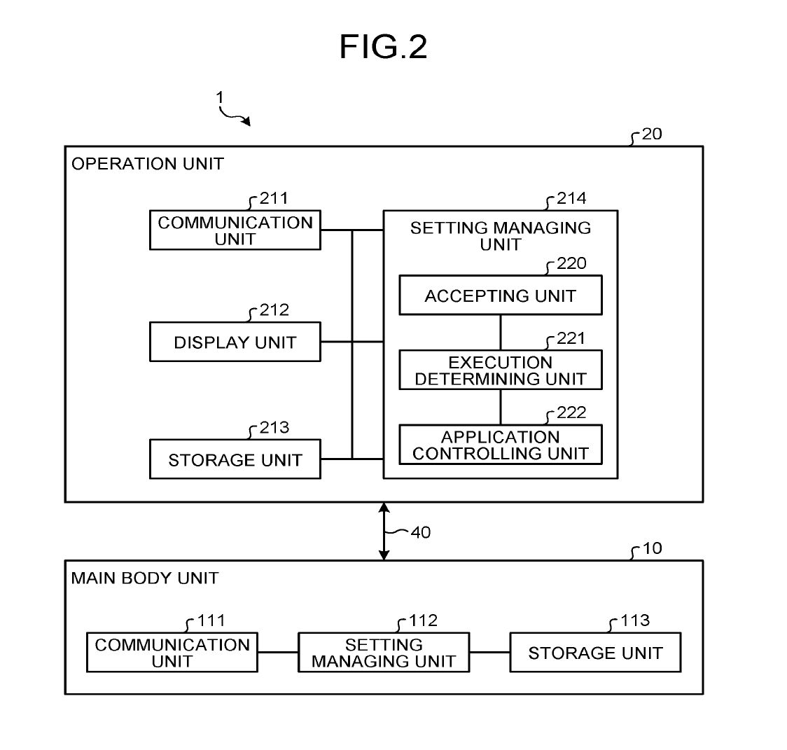

Exemplary functional blocks of the MFP 1 implemented by the hardware in FIG. 1 are described next. FIG. 2 is a diagram illustrating exemplary functional blocks in the MFP in the first embodiment. As illustrated in FIG. 2, the MFP 1 includes the main body unit 10 and the operation unit 20.

The main body unit 10 includes a communication unit 111, a setting managing unit 112, and a storage unit 113, each of which is a function (module) to be implemented when the CPU 11 runs a computer program. Each of some of the above units may be software (a computer program) that causes the corresponding one of the above units to be loaded onto the RAM 13 and generated on the RAM 13 when the CPU 11 reads out and executes the software (the computer program) from the ROM 12 or the HDD 14. In addition, some or all of the above units may be replaced with hardware circuitry such as a processor that performs arithmetic processing corresponding to the some or all of the above units.

The communication unit 111 is implemented when the CPU 11 executes instructions read out thereby from the ROM 12. The communication unit 111 connects to the operation unit 20 through the dedicated communication path 40, thereby transmitting and receiving data to and from the operation unit 20. For example, the communication unit 111 receives various pieces of operational input accepted by the operation unit 20 and transfers these pieces of operational input to the corresponding units. The communication unit 111 transmits data to be used for displaying various pieces of information (such as information corresponding to input accepted, information indicating the operational status of the MFP 1, and information indicating conditions of settings) on the operation unit 20.

The communication unit 111 also transmits and receives data to and from an external apparatus (such as a client PC) through the network 30 by way of the communication I/F 15 and transfers data to the corresponding units.

The setting managing unit 112 is implemented when the CPU 11 executes instructions read out thereby from the ROM 12. The setting managing unit 112 manages an import (input) request or export (output) request for setting information (setting values) that is made by an outside party such as a user and accepted by the setting managing unit 214 in the operation unit 20.

For example, upon accepting an import request or export request for a set of setting information on an application (a main body unit application) that operates in the main body unit 10, the setting managing unit 112 requests the main body unit application to execute processing corresponding to the accepted request. For example, upon accepting an import request or export request for a set of setting information on an application (an operation unit application) that operates in the operation unit 20, the setting managing unit 112 requests the setting managing unit 214 in the operation unit 20 to execute processing corresponding to the accepted request.

Examples of the foregoing main body unit application (a second unit application) include, but are not limited to, applications such as a copy application for providing a copy function, a scanner application for providing a scanner function, and a facsimile application for providing a facsimile application. That is, any processing unit (such as software), setting information on which can be imported and exported, that operates in the main body unit 10 can be set as a main body unit application.

Examples of the foregoing operation unit application (a first unit application) include, but are not limited to, a display application for displaying various pieces of information on the operation panel 27 in the operation unit 20, a setting application for making various settings on the operation unit 20, a launcher for controlling startup of the other applications and the like that operate in the operation unit 20, and a browser for providing a browser function such as displaying web pages. That is, any processing unit (such as software), setting information on which can be imported and exported, that operates in the operation unit 20 can be set as an operation unit application.

Upon accepting export requests on main body unit applications and operation unit applications, the setting managing unit 112 acquires sets of setting information on the respective main body unit applications from the storage unit 113, and acquires sets of setting information on the respective operation unit applications from the setting managing unit 214 in the operation unit 20. The setting managing unit 112 unifies these sets of setting information, and then performs control so that a resultant unified set of setting information can be output (exported) to an outside party such as the user through the communication unit 111.

Upon receiving import requests on main body unit applications and operation unit applications, the setting managing unit 112 stores, in the storage unit 113, sets of setting information to be imported to the respective applications. The setting managing unit 112 requests the individual main body unit applications to import to the setting managing unit 112 sets of setting information stored in the storage unit 113. The setting managing unit 112 also requests the setting managing unit 214 in the operation unit 20 to import sets of setting information stored in the storage unit 113 that correspond to the respective operation unit applications.

Setting information to be imported is, for example, setting information exported from an apparatus such as the MFP 1 or another MFP, and contains setting information on at least one main body unit application and/or setting information on at least one operation unit application.

The storage unit 113 corresponds to the ROM 12 or the HDD 14. The storage unit 113 stores therein various kinds of data. The storage unit 113 stores therein, for example, the main body unit applications, which operate in the main body unit 10. The storage unit 113 also stores therein a set of setting information on an individual application that is to be exported or imported.

The operation unit 20 includes a communication unit 211, a display unit 212, a storage unit 213, and a setting managing unit 214, each of which is a function (module) to be implemented when the CPU 21 runs a computer program. The setting managing unit 214 includes an accepting unit 220, an execution determining unit 221, and an application controlling unit 222. Each of some of the above units may be software (a computer program) that causes the corresponding one of the above units to be loaded onto the RAM 23 and generated on the RAM 23 when the CPU 21 reads out and executes the software (the computer program) from the ROM 22 or the flash memory 24. In addition, some of the above units may be replaced with hardware circuitry such as a processor that performs arithmetic processing corresponding to the some of the above units.

The communication unit 211 is implemented when the CPU 21 executes instructions read out thereby from the ROM 22. The communication unit 211 connects to the main body unit 10 through the dedicated communication path 40, thereby transmitting and receiving data to and from the main body unit 10. For example, the communication unit 211 transmits, to the setting managing unit 112 in the main body unit 10, import requests or export requests, for setting information on any main body unit application and any operation unit application, that have been accepted by the accepting unit 220 in the setting managing unit 214. In addition, the communication unit 211 accepts an export request or import request for setting information on any operation unit application from the setting managing unit 112 in the main body unit 10.

The communication unit 211 transmits to the main body unit 10, for example, various pieces of input that have been accepted by the operation unit 20. The communication unit 211 receives data to be used for displaying various pieces of information (such as information corresponding to input accepted, information indicating the operational status of the MFP 1, and information indicating conditions of settings) on the operation unit 20, and transfers the data to the corresponding units.

The communication unit 211 also transmits and receives data to and from an external apparatus (such as a client PC) through the network 30 by way of the communication I/F 25 and transfers data to the corresponding units. Specifically, the communication unit 211 receives, from an external apparatus, instructions and data for implementing functions, and transfers the received instructions and data to the corresponding units.

The display unit 212 corresponds to a display screen in the operation panel 27. The display unit 212 displays, for example, display information (a screen) for providing information to the user. The display unit 212 also displays, for example, an always displayed screen for using a particular function.

The storage unit 213 corresponds to the ROM 22 or the flash memory 24. The storage unit 113 stores therein various kinds of data. The storage unit 213 stores therein, for example, the operation unit applications, which operate in the operation unit 20. The storage unit 213 also stores therein a set of setting information on an operation unit application that has been exported from the operation unit application.

A display application, which is an example of the operation unit application, controls display of information on the operation panel 27 in response to requests from image display libraries embedded in the respective modules in the main body unit 10. A setting application, which is an example of the operation unit application, sets a sound volume in a case when the operation unit 20 is equipped with a speaker, sets a communication method, and sets a password for authentication, for example.

Examples of the operation unit application may include an application (third-party application) produced by a third party (for example, a third vendor). In this case, for example, any necessary service may be provided to the third-party application. Such a service is provided for hiding, for example, an interface that enables a third party to produce an application without detailed knowledge on operations and specifications of the main body unit 10, and an interface that cannot be made public.

The setting managing unit 214 includes the accepting unit 220, the execution determining unit 221, and the application controlling unit 222. The setting managing unit 214, the accepting unit 220, the execution determining unit 221, and the application controlling unit 222 are implemented when the CPU 21 executes instructions read out thereby from the ROM 22.

The accepting unit 220 accepts, from the outside (such as the user) through the communication unit 211 or the display unit 212, an export request or import request for setting information on any application (for example, an operation unit application or a main body unit application) that operates in the MFP 1.

If the accepting unit 220 has accepted an export request or import request for setting information, the execution determining unit 221 acquires the operational status of the main body unit 10. This embodiment describes an example in which operation signals acquired from the main body unit 10 are used for the operational status. The operation signals may be signals to be transmitted on a regular basis or may be signals to be transmitted upon request.

The execution determining unit 221 determines, based on the acquired operational status, whether the main body unit 10 can execute processing (input/output processing for setting information) corresponding to the request accepted by the accepting unit 220. This embodiment describes an example in which it is determined whether the processing can be immediately executed; however, the embodiment is not limited to determining whether it can be immediately executed, and it may be determined, for example, whether the processing can be executed within a certain time period.

In this embodiment, the execution determining unit 221 determines whether the operational status of the main body unit 10 is any one of the following: a state where the main body unit 10 is in the power saving mode“; a state where the HDD 14 is unusable (in preparation)”; and a state where “a user is browsing or making settings for the main body unit 10”. If the operational status is any one of these states, the execution determining unit 221 determines that the main body unit 10 is temporarily unusable. If the main body unit 10 is temporarily unusable, the main body unit 10 is unable to execute processing corresponding to an export request or import request. Therefore, if the main body unit 10 is in any one of these states as the operational status, the execution determining unit 221 in this embodiment determines that the main body unit 10 is unable to immediately execute processing corresponding to the foregoing request. This embodiment is not intended to limit the operational status to these states, and other states may be used as the operational status for determining whether the processing can be executed.

The application controlling unit 222 controls execution on individual operation unit applications such as the display application, the setting application, the launcher, and the browser, which are described above. For example, if the execution determining unit 221 has determined that the main body unit 10 is unable to immediately execute the processing corresponding to the foregoing request, the application controlling unit 222 causes the operation unit applications to execute the processing corresponding to the foregoing request in advance.

If the execution determining unit 221 has determined that the main body unit 10 can execute the processing corresponding to the foregoing request, the setting managing unit 214 transfers, to the setting managing unit 112 in the main body unit 10 through the communication unit 211, the content of the export request or import request for setting information accepted by the accepting unit 220.

Upon accepting export requests on operation unit applications from the setting managing unit 112 in the main body unit 10 through the communication unit 211, the setting managing unit 214 acquires, from the storage unit 213, sets of setting information acquired when the respective operation unit applications execute export processing in advance. The setting managing unit 214 unifies the respective sets of setting information acquired, and transmits the unified setting information to the setting managing unit 112 in the main body unit 10 through the communication unit 211.

Upon accepting import requests on operation unit applications from the setting managing unit 112 in the main body unit 10 through the communication unit 211, the setting managing unit 214 acquires, from the storage unit 213, import results acquired when the operation unit applications execute import processing in advance. The setting managing unit 214 unifies the respective import results acquired, and transmits the unified results to the setting managing unit 112 in the main body unit 10 through the communication unit 211.

Examples of Data Structure of Setting Information

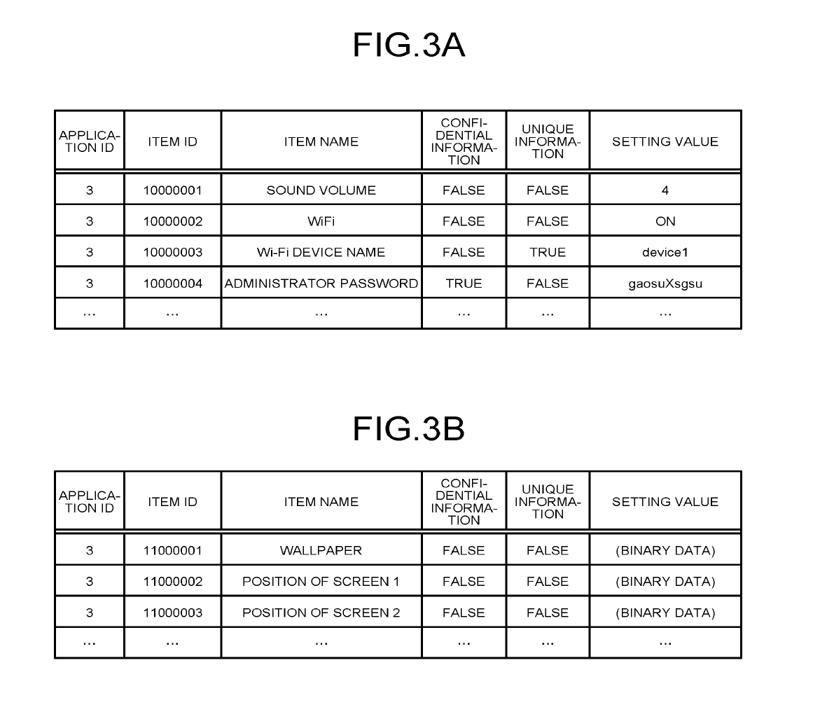

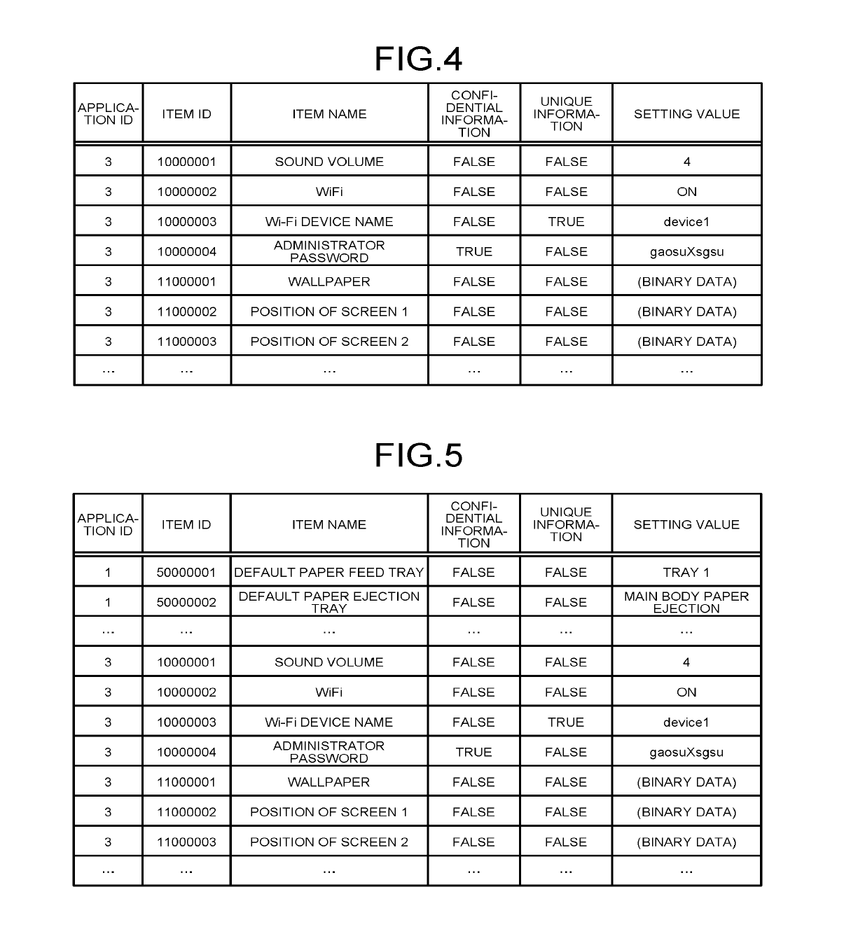

Next, examples of the data structure of setting information are described with reference to FIG. 3A to FIG. 5. FIGS. 3A and 3B are diagrams illustrating exemplary sets of setting information that are processed by the operation unit applications. FIG. 4 is a diagram illustrating an exemplary set of setting information that is transmitted and received between the operation unit and the main body unit. FIG. 5 is a diagram illustrating an exemplary set of setting information that is finally generated by the setting managing unit in the main body unit.

FIG. 3A illustrates an exemplary set of setting information on a setting application, which is an exemplary operation unit application. FIG. 3B illustrates an exemplary set of setting information on a launcher, which is an exemplary operation unit application. As illustrated in FIG. 3A and FIG. 3B, each set of the setting information contains items such as “application ID”, “item ID”, “item names”, “confidential information”, “unique information”, and “setting values”.

The application ID is identification information with which applications are identified. For example, pieces of the application ID are assigned to applications set as export sources in the main body unit 10, and to the setting managing unit 214 in the operation unit 20, which is treated as an application. The item ID is identification information with which individual setting items contained in setting information are identified. The item names are names for the setting items.

The confidential information indicates whether each of the setting items is information that needs to be kept confidential. For example, “TRUE” is set when the setting item is information that needs to be kept confidential, while “FALSE” is set when the setting item is not information that needs to be kept confidential. When the confidential information is “TRUE”, the setting managing unit 112 in the main body unit 10 may encrypt the setting information (setting values) and export the encrypted setting information, for example.

The unique information indicates whether each of the setting items is information unique to the apparatus. For example, “TRUE” is set when the setting item is information unique to the apparatus, while “FALSE” is set when the setting item is not information unique to the apparatus. The setting values are values set for the respective setting items.

FIG. 4 is a diagram illustrating an exemplary set of setting information that is transmitted and received between the operation unit and the main body unit. The exemplary set of setting information in FIG. 4 represents setting information obtained by unifying the sets of setting information in FIG. 3A and FIG. 3B. The setting managing unit 214 in the operation unit 20 notifies the setting managing unit 112 in the main body unit 10 of all of the sets of setting information generated by the operation unit applications in the operation unit 20, in a unified manner.

FIG. 5 is a diagram illustrating an example of setting information that the setting managing unit in the main body unit finally generates. The setting managing unit 112 in the main body unit 10 generates a set of setting information obtained by unifying a set of setting information on applications in the main body unit 10 with the set of setting information illustrated in FIG. 4 described above, and outputs the generated set of setting information as a set of final setting information (such as an export file) to the outside.

The example in FIG. 5 illustrates an exemplary set of setting information obtained by unifying, with setting information corresponding to the application ID of 1 that has been provided as setting information on applications in the main body unit 10, the setting information corresponding to the application ID of 3 illustrated in FIG. 4 described above.

In import processing in this embodiment, the setting information as illustrated in FIG. 5 is input as setting information on an import destination (such as an import file).

Next, export or import processing to be executed by the foregoing MFP 1 is described. First, a case where the accepting unit 220 in the operation unit 20 accepts an export request or import request from the outside is described.

When Import Request or Export Request is Accepted from Outside

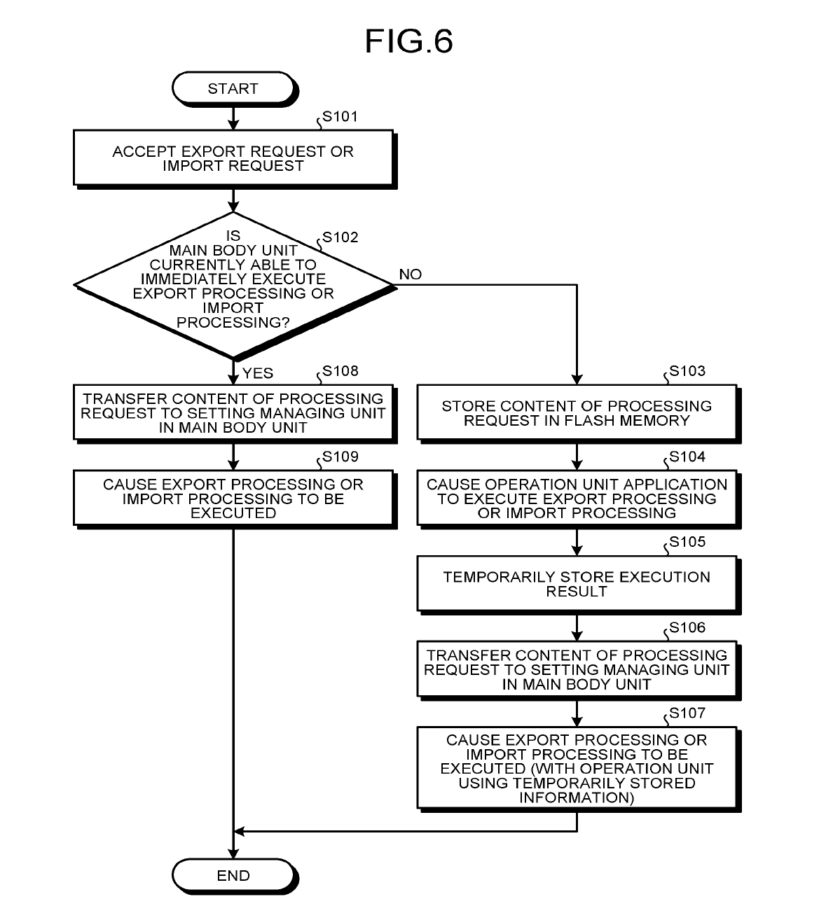

FIG. 6 is a flowchart applicable when an export request or import request is accepted from the outside. As illustrated in FIG. 6, the accepting unit 220 in the operation unit 20 accepts an export request or import request from the outside through the communication unit 211 or the display unit 212 (Step S101). The execution determining unit 221 in the operation unit 20 acquires the operational status from the main body unit 10, and determines based on the acquired operational status whether the main body unit 10 is able to immediately execute export or import processing (Step S102).

As described above, the execution determining unit 221 in the operation unit 20 determines whether the operational status of the main body unit 10 is any one of the following: a state where the main body unit 10 is in the power saving mode“; a state where the HDD 14 is unusable (in preparation)”; and a state where “a user is browsing or making settings for the main body unit 10”. If the operational status is any one of these states, the execution determining unit 221 in the operation unit 20 determines that the main body unit 10 is currently unable to immediately execute export processing or import processing.

If the execution determining unit 221 in the operation unit 20 has determined that the main body unit 10 is currently unable to immediately execute export processing or import processing (No at Step S102), the setting managing unit 214 in the operation unit 20 stores, in the flash memory 24 (the storage unit 213), the content of the processing request accepted at Step S101 (Step S103).

Subsequently, based on the processing request accepted at Step S101, the application controlling unit 222 in the operation unit 20 causes an operation unit application in the operation unit 20 to execute export processing or import processing in advance of the main body unit 10 (Step S104), the operation unit application having been designated as an export source or an import destination. The operation unit application temporarily stores the execution result in the flash memory 24 (Step S105).

Subsequently, if the execution determining unit 221 in the operation unit 20 has determined based on the operational status of the main body unit 10 that the main body unit 10 has become able to execute the export or import processing, the setting managing unit 214 in the operation unit 20 transfers, to the setting managing unit 112 in the main body unit 10, the content of the processing request stored in the processing at Step S103 (Step S106).

The setting managing unit 112 in the main body unit 10 causes the main body unit applications or the setting managing unit 214 in the operation unit 20 to execute the export or import processing (Step S107). After this step, upon accepting, from the setting managing unit 112 in the main body unit 10, a request for executing the export or import processing, the setting managing unit 214 in the operation unit 20 transmits information (the execution result) temporarily stored in the flash memory in the processing at Step S105 to the setting managing unit 112 in the main body unit 10.

If the execution determining unit 221 in the operation unit 20 has determined that the main body unit 10 is able to immediately execute the export or import processing in the processing at Step S102 (Yes at Step S102), the setting managing unit 214 in the operation unit 20 transfers the content of the processing request to the setting managing unit 112 in the main body unit 10 (Step S108). Subsequently, the setting managing unit 112 in the main body unit 10 causes the main body unit application or the setting managing unit 214 in the operation unit 20 to execute the export processing or import processing (Step S109), and ends processing.

Thus, when the main body unit 10 is currently unable to immediately execute export processing or import processing, the application controlling unit 222 in the operation unit 20 causes an operation unit application to execute export processing or import processing in advance of the main body unit 10. The time to be taken for processing in the operation unit 20 after the main body unit 10 has become able to execute export processing or import processing can be reduced consequently.

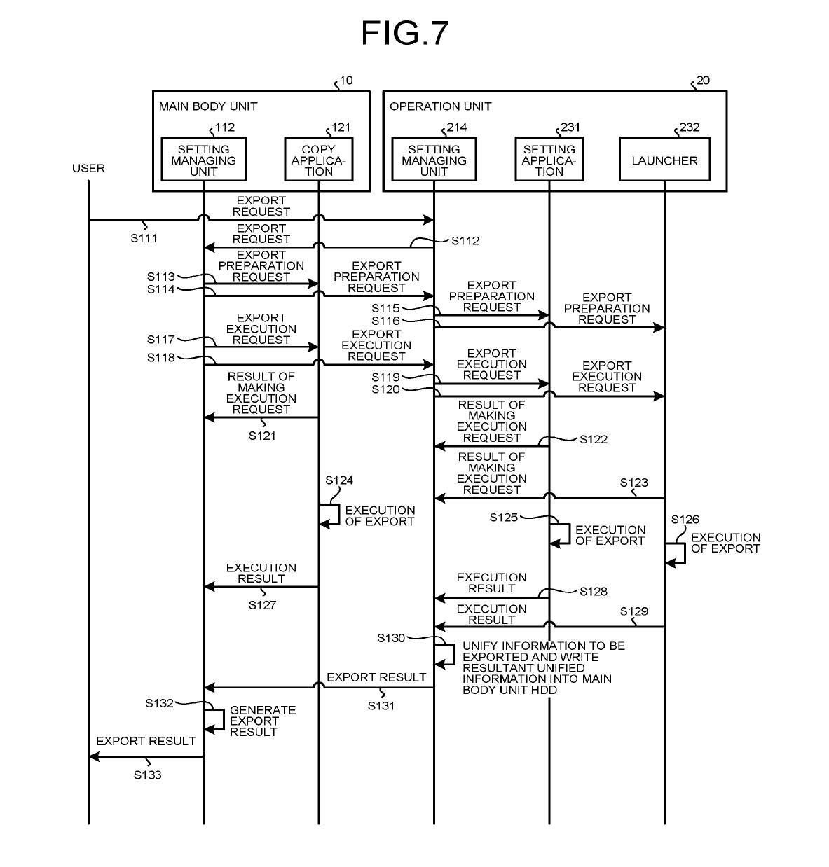

Next, specific examples of export processing and import processing that are performed by the MFP 1 are described with reference to FIG. 7 to FIG. 14.

Sequence of Export Processing

FIG. 7 is a sequence illustrating an example of export processing in the first embodiment. The example of FIG. 7 represents an example in which the main body unit 10 is currently able to immediately execute export processing. The sequence illustrated in FIG. 7 is executed by: the setting managing unit 112 in the main body unit 10; a copy application 121, which is an exemplary main body unit application; the setting managing unit 214 in the operation unit 20; and a setting application 231 and a launcher 232, which are exemplary operation unit applications. Exemplary main body unit applications and operation unit applications are not limited to this case.

As illustrated in FIG. 7, the setting managing unit 214 in the operation unit 20 accepts an export request from the outside (for example, such as a user) through the accepting unit 220 (Step S111).

If the execution determining unit 221 has determined based on the operational status of the main body unit 10 that, for example, the main body unit 10 is currently able to immediately execute export processing, the setting managing unit 126 in the operation unit 20 transmits an export request to the setting managing unit 112 in the main body unit 10 (Step S112). An export request may include designation of such information as: applications set as export sources; and an output destination to which setting information (such as an export file) is finally exported.

The setting managing unit 112 in the main body unit 10 transmits an export preparation request to applications (the copy application 121 and the setting managing unit 214 in the operation unit 20 in the example of FIG. 7) designated as export sources (Step S113 and Step S114).

Upon accepting an export preparation request from the setting managing unit 112 in the main body unit 10, the setting managing unit 214 in the operation unit 20 causes the application controlling unit 222 to transmit export preparation requests to operation unit applications (the setting application 231 and the launcher 232 in the example in FIG. 7) specified as export sources in the operation unit 20 (Step S115 and Step S116).

Here, an export preparation request is a request for each application to execute processing that is needed to be executed before setting information is exported therefrom. The sequence may be configured to, when such processing is not needed, skip transmitting the export preparation request.

The setting managing unit 112 in the main body unit 10 determines an application specified at the same time as issuance of an export request to be an export source, for example; however, an application to be set as an export source may be determined in any manner, and a previously determined application may be set as an export source.

The setting managing unit 112 in the main body unit 10 may broadcast an export preparation request without specifying destinations (applications). In this case, an application that has received an export preparation request executes processing corresponding to the request if this application is an export source.

Similarly, the setting managing unit 214 in the operation unit 20 causes the application controlling unit 222 to transmit export preparation requests to designated operation unit applications, for example. When the OS of the operation unit 20 is Android (registered trademark), a method such as “sendOrderedBroadcast” may be used for the broadcasting. An operation unit application that has received an export preparation request executes processing corresponding to the request if this application is as an export source. Each application may determine, based on information set in advance in the flash memory 24 or the like, whether the application is an export source.

Subsequently, the setting managing unit 112 in the main body unit 10 transmits an export execution request to applications (the copy application 121 and the setting managing unit 214 in the operation unit 20 in the example of FIG. 7) specified as export sources (Step S117 and Step S118).

Upon receiving an export execution request from the setting managing unit 112 in the main body unit 10, the setting managing unit 214 in the operation unit 20 causes the application controlling unit 222 to transmit export execution requests to operation unit applications in the operation unit 20 (the setting application 231 and the launcher 232 in the example in FIG. 7) designated as export sources (Step S119 and Step S120). As in the case of export preparation requests, export execution requests may be transmitted to applications set as export sources or may be broadcast.

The respective applications set as export sources that have received the export execution requests transmit, to the transmitters of the export execution requests, results of making the execution requests (Step S121, Step S122, and Step S123).

In addition, each of the applications executes export processing in which to write setting information (information to be exported) thereof into, for example, a designated or predetermined storage unit. For example, the copy application 121 in the main body unit 10 writes setting information thereon into the HDD 14 (Step S124). For example, the setting application 231 and the launcher 232 in the operation unit 20 write setting information thereon into the flash memory 24 (Step S125 and Step S126).

The respective applications transmit export results to the transmitters of the export execution requests. For example, the copy application 121 transmits an execution result to the setting managing unit 112 in the main body unit 10 (Step S127). The setting application 231 and the launcher 232 transmit execution results to the setting managing unit 214 in the operation unit 20 (Step S128 and Step S129). Each of the execution results may contain information (such as application ID) with which to identify an application that has executed the export, and/or information with which to identify the exported setting information (such as where an export file is stored, and the name thereof).

Upon receiving the results of the execution from the respective applications (the setting application 231 and the launcher 232 in the example in FIG. 7) in the operation unit 20, the setting managing unit 214 in the operation unit 20 reads out sets of setting information that have been stored by the respective applications, and generates a unified set of setting information. The setting managing unit 126 in the operation unit 20 writes the generated unified set of setting information into a storage unit (for example, the HDD 14) in the main body unit 10 (Step S130). The setting managing unit 214 in the operation unit 20 transmits an execution result of execution of the writing processing (an export result) to the setting managing unit 112 in the main body unit 10 (Step S131).

Upon receiving the execution results from the applications set as export sources, the setting managing unit 112 in the main body unit 10 reads out sets of setting information that have been stored by the respective applications, and generates unified setting information (an export result) obtained by unifying the sets of setting information that have been read out (Step S132). The setting managing unit 112 in the main body unit 10 outputs the export result (an export file) (Step S133). For example, the setting managing unit 112 in the main body unit 10 writes the export result into the HDD 14 and notifies an export requester of the result of the writing.

As described above, when the main body unit 10 is currently able to immediately execute export processing in response to an export request accepted from the outside, the setting managing unit 214 in the operation unit 20 notifies the setting managing unit 112 in the main body unit 10 of the export request. Once the setting managing unit 112 in the main operation unit 10 has identified any operation unit application in the operation unit 20 as an application set as an export source, the application controlling unit 222 in the operation unit 20 subjects the operation unit application to export processing exclusively applicable to operation unit applications in the operation unit 20.

Flows of Individual Sets of Information in Export Processing

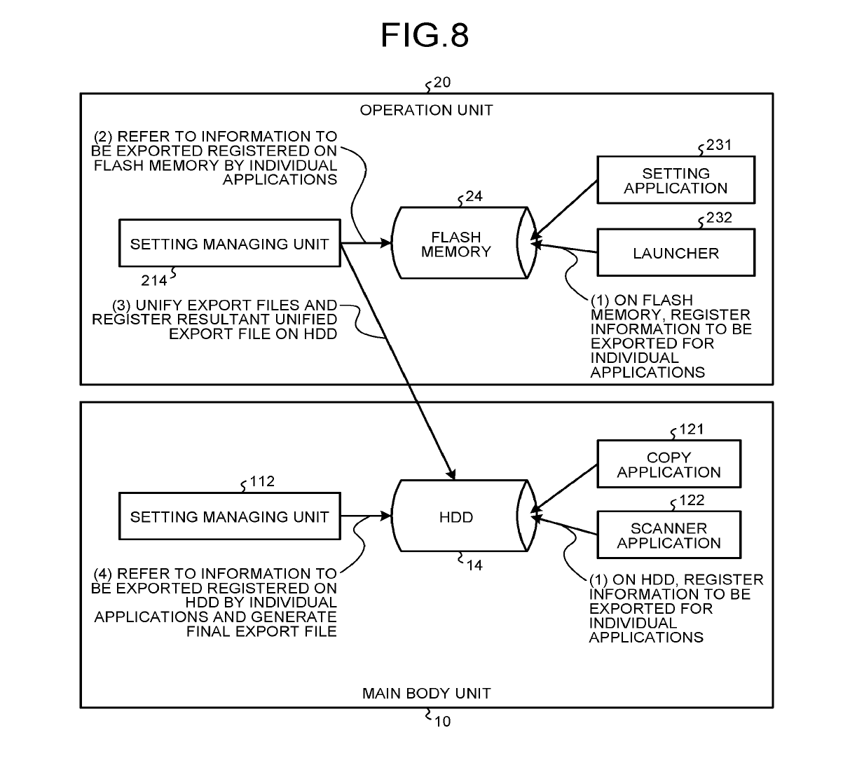

FIG. 8 is a diagram explaining flows of individual sets of information in export processing. The example in FIG. 8 represents an example in which, for example, the copy application 121, the scanner application 122, the setting application 231, and the launcher 232 have been designated as applications set as export sources.

In the export processing illustrated in FIG. 8, each of the applications set as export sources stores, in a storage unit (the HDD 14 or the flash memory 24), information (setting information) thereof to be exported. For example, the copy application 121 and the scanner application 122 store, in the HDD 14, information to be exported (the lower (1) in FIG. 8). The setting application 231 and the launcher 232 store, in the flash memory 24, sets of information to be exported (the upper (1) in FIG. 8).

The setting managing unit 214 in the operation unit 20 refers to the sets of information to be exported that have been stored in the flash memory 24 by the operation unit applications (the setting application 231 and the launcher 232 in the example in FIG. 8) in the operation unit 20 ((2) in FIG. 8). The setting managing unit 214 in the operation unit 20 unifies, into an export file for the entire operation unit 20, the sets of information to be exported that have been acquired by the referring, and then registers the export file on the HDD 14 in the main body unit 10 ((3) in FIG. 8).

The setting managing unit 112 in the main body unit 10 further unifies sets of information to be exported that have been registered on the HDD 14 by individual applications (including the setting managing unit 214 in the operation unit 20) for the purpose of outputting the information to the outside (and edits the information as needed), thereby generating a final export file ((4) in FIG. 8).

Sequence with Main Body Unit 10 Being Unable to Immediately Execute Export Processing

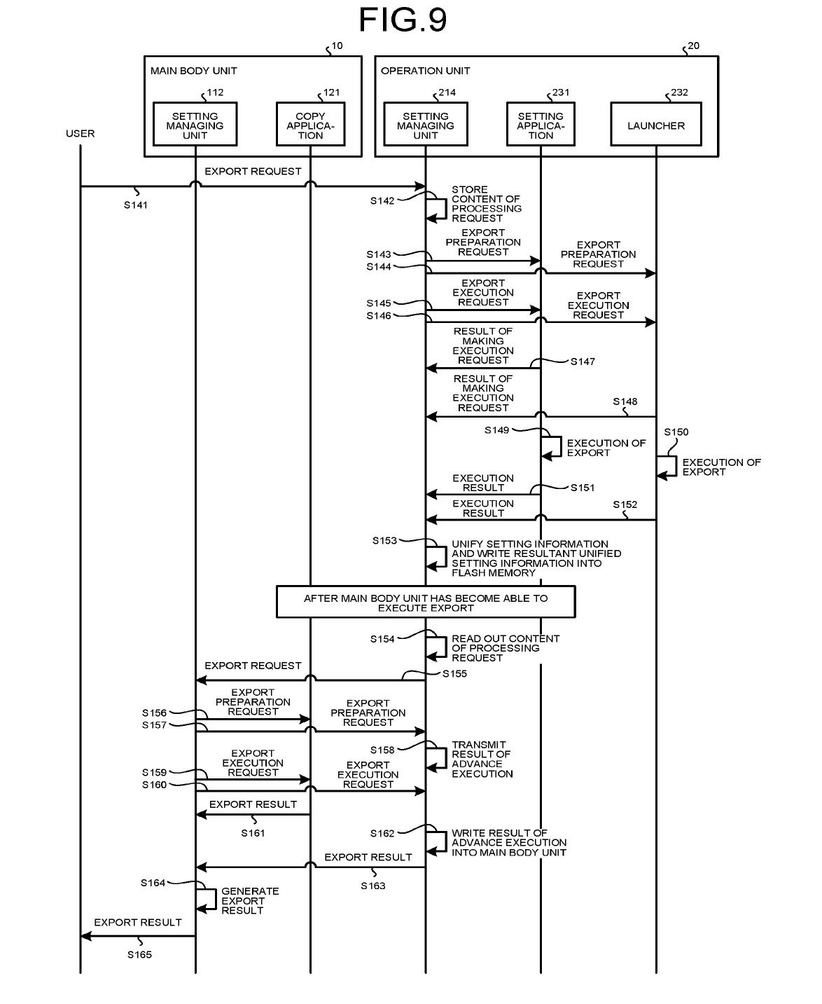

FIG. 9 is a sequence applicable when the main body unit is currently unable to immediately execute export processing. The sequence illustrated in FIG. 9 is executed by: the setting managing unit 112 in the main body unit 10; the copy application 121, which is an exemplary main body unit application; the setting managing unit 214 in the operation unit 20; and the setting application 231 and the launcher 232, which are exemplary operation unit applications.

As illustrated in FIG. 9, the setting managing unit 214 in the operation unit 20 accepts an export request from the outside (for example, such as a user) through the accepting unit 220 (Step S141).

If the execution determining unit 221 has determined based on the operational status of the main body unit 10 that, for example, the main body unit 10 is currently unable to immediately execute export processing, the setting managing unit 214 in the operation unit 20 stores the export request (the content of requested processing) in the storage unit 213 (the flash memory 24) in the operation unit 20 (Step S142).

Subsequently, the setting managing unit 214 in the operation unit 20 causes the application controlling unit 222 to cause operation unit applications in the operation unit 20 to execute export processing.

That is, the setting managing unit 214 in the operation unit 20 causes the application controlling unit 222 to transmit export preparation requests and export execution requests to operation unit applications in the operation unit 20 (the setting application 231 and the launcher 232 in the example in FIG. 9) designated as export sources (Step S143 to Step S146). The respective applications that have received the export execution requests transmit, to the transmitter of the export execution requests, results of making execution requests (Step S147 and Step S148).

The respective applications in the operation unit 20 execute export processing (Step S149 and Step S150), and transmit export results to the transmitter of the export execution requests (Step S151 and Step S152). Upon receiving the results of the execution from the respective applications in the operation unit 20, the setting managing unit 214 in the operation unit 20 reads out sets of setting information stored by the respective applications, unifies these sets of setting information, and writes a resultant unified set of setting information into the flash memory 24 (Step S153).

After this step, when the execution determining unit 221 has determined based on the operational status of the main body unit 10 that the main body unit 10 has become able to execute export processing, the setting managing unit 214 in the operation unit 20 reads out the content of processing request stored in a storage such as the flash memory 24 in the processing at Step S142 (Step S154).

The execution determining unit 221 in the operation unit 20 determines whether the operational status of the main body unit 10 is any one of the following: a state where the main body unit 10 has returned to “the normal mode” from “the power saving mode”; a state where “the HDD 14 is usable”, back from the state where “the HDD 14 is unusable (in preparation)”; and a state where “the user has ended browsing or making settings for the main body unit 10”, back from the state where “the user is browsing or making settings for the main body unit 10”. The execution determining unit 221 in the operation unit 20 determines, when the operational status is any one of these states, that the main body unit 10 has become able to execute export processing. However, this is not a limiting example.

The setting managing unit 214 in the operation unit 20 transmits an export request to the setting managing unit 112 in the main body unit 10 (Step S155).

As in the processing illustrated in FIG. 7 described above, the setting managing unit 112 in the main body unit 10 causes export processing to be executed, that is, transmits export preparation requests and export execution requests to applications (the copy application 121 and the setting managing unit 214 in the operation unit 20 in the example of FIG. 9) designated as export sources (Step S156, Step S157, Step S159, and Step S160).

In response to the export preparation request from the setting managing unit 112 in the main body unit 10, the setting managing unit 214 in the operation unit 20 transmits a result of advance execution (Step S158). The application in the main body unit 10 (the copy application 121 in the example in FIG. 9) transmits an export result to the setting managing unit 112 in the main body unit 10 (Step S161). In response to the export execution request from the setting managing unit 112 in the main body unit 10, the setting managing unit 214 in the operation unit 20 acquires a result of the execution stored in advance from the flash memory 24, and writes the result of the execution into the storage unit 113 (for example, the HDD 14) in the main body unit 10 (Step S162).

The setting managing unit 214 in the operation unit 20 transmits an execution result of the writing processing to the setting managing unit 112 in the main body unit 10 (Step S163). Upon receiving the execution results from the respective applications set as export sources, the setting managing unit 112 in the main body unit 10 generates an export result (Step S164), and outputs the export result as in the case of FIG. 7 (Step S165).

As described above, when the main body unit 10 is currently unable to immediately execute export processing in response to an export request accepted from the outside, the application controlling unit 222 in the operation unit 20 causes export processing to be executed before the main body unit 10 executes the export processing. The time to be taken for processing in the operation unit 20 after the main body unit 10 has become able to execute export processing can be reduced consequently, so that the time to be taken for completing export processing in the entire MFP 1 can be reduced.

Flows of Individual Sets of Information in Export Processing when Immediately Execution by Main Body Unit 10 is Impossible

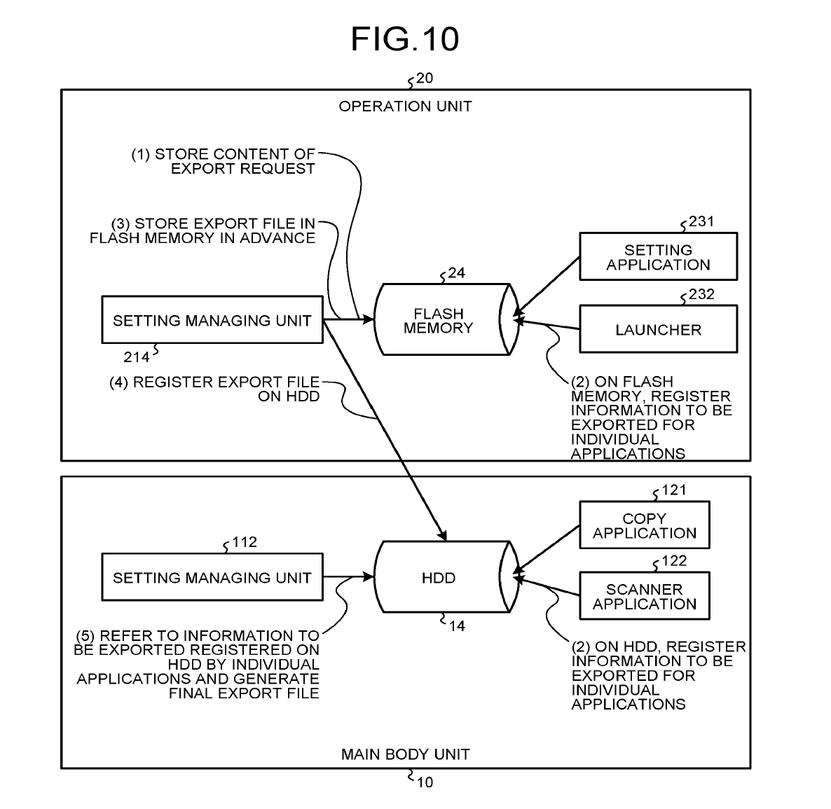

FIG. 10 is a diagram explaining flows of individual sets of information in a case when the main body unit is currently unable to immediately execute export processing. The example in FIG. 10 represents an example in which, for example, the copy application 121, the scanner application 122, the setting application 231, and the launcher 232 have been designated as applications set as export sources.

In export processing illustrated in FIG. 10, the setting managing unit 214 in the operation unit 20 stores the content of an export request from the outside in the flash memory 24 ((1) in FIG. 10).

In order to execute export processing in advance, the respective applications set as export sources in the operation unit 20 register, on the flash memory 24, sets of information (setting information) thereof to be exported (the upper (2) in FIG. 10). The setting managing unit 214 in the operation unit 20 generates an export file for the entire operation unit 20 with reference to sets of information to be exported that have been registered on the flash memory 24 by the respective applications in the operation unit 20, and stores the export file in the flash memory 24 in advance ((3) in FIG. 10).

If the execution determining unit 221 has determined based on the operational status of the main body unit 10 that the main body unit 10 has become able to execute export processing, the setting managing unit 214 in the operation unit 20 transmits the content of the export request that has been stored in the flash memory 24 to the setting managing unit 112 in the main body unit 10. Consequently, export processing is started in the main body unit 10.

Applications designated as export sources in the main body unit 10 register, on the HDD 14, sets of information thereof to be exported. The setting managing unit 214 in the operation unit 20 reads out, from the flash memory 24, the export file for the entire operation unit 20 that has been generated in advance, and registers the read-out export file on the HDD 14 ((4) in FIG. 10). The setting managing unit 112 in the main body unit 10 generates a final export file with reference to the sets of information to be exported that have been registered on the HDD 14 by the respective applications ((5) in FIG. 10).

Sequence of Import Processing

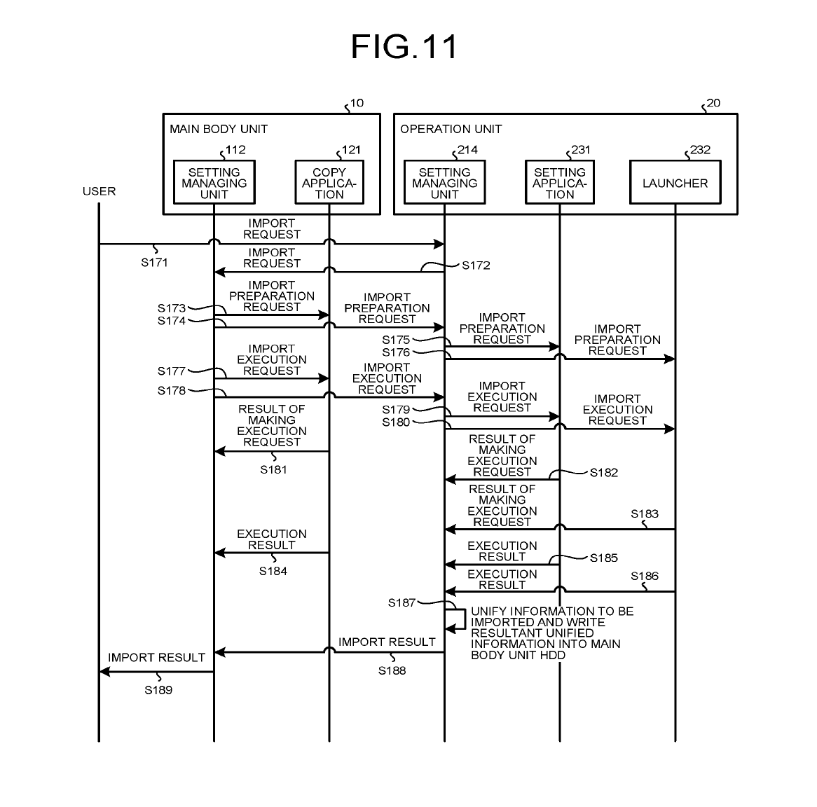

FIG. 11 is a sequence illustrating an example of import processing in the first embodiment. The example of FIG. 11 represents an example in which the main body unit 10 is currently able to immediately execute import processing. The sequence illustrated in FIG. 11 is executed by: the setting managing unit 112 in the main body unit 10; the copy application 121, which is an exemplary main body unit application; the setting managing unit 214 in the operation unit 20; and the setting application 231 and the launcher 232, which are exemplary operation unit applications.

As illustrated in FIG. 11, the setting managing unit 126 in the operation unit 20 accepts an import request from the outside (such as the user, for example) through the accepting unit 220 (Step S171).

If the execution determining unit 221 has determined based on the operational status of the main body unit 10 that, for example, the main body unit 10 is currently able to immediately execute import processing, the setting managing unit 124 in the operation unit 20 transmits an import request to the setting managing unit 112 in the main body unit 10 (Step S172). An import request may include designation of such information as: applications set as import destinations; and setting information (such as an import file) to be imported.

The setting managing unit 112 in the main body unit 10 transmits import preparation requests to applications (the copy application 121 and the setting managing unit 214 in the operation unit 20 in the example of FIG. 11) designated as import destinations (Step S173 and Step S174).

Upon receiving the import preparation request from the setting managing unit 112 in the main body unit 10, the setting managing unit 214 in the operation unit 20 causes the application controlling unit 222 to transmit import preparation requests to operation unit applications (the setting application 231 and the launcher 232 in the example in FIG. 11) designated as import destinations in the operation unit 20 (Step S175 and Step S176).

Here, an import preparation request is a request for each application to execute processing that is needed to be executed before setting information is imported thereto. The sequence may be configured to, when such processing is not needed, skip transmitting the import preparation request. As in the cases of an export preparation requests and export execution requests, import preparation requests may be transmitted to applications set as import destinations or may be broadcast.

Subsequently, the setting managing unit 112 in the main body unit 10 transmits import execution requests to the applications (the copy application 121 and the setting managing unit 214 in the operation unit 20 in the example of FIG. 11) designated as import destinations (Step S177 and Step S178).

Upon receiving the import execution request from the setting managing unit 112 in the main body unit 10, the setting managing unit 214 in the operation unit 20 causes the application controlling unit 222 to transmit import execution requests to the designated operation unit applications (the setting application 231 and the launcher 232 in the example in FIG. 11) in the operation unit 20 (Step S179 and Step S180). As in the case of import preparation requests, import execution requests may be transmitted to applications set as import destinations or may be broadcast.

The respective applications set as import destinations that have received the import execution requests transmit, to the transmitter of the import execution requests, results of making the execution requests (Step S181 to Step S183).

Each of the applications may calculate, with reference to sets of setting information (information to be imported) assigned respectively to a storage unit (for example, the HDD 14) and the like, the number of setting items (the number of imports) designated as those requested to be imported in the import execution request, and returns, as the above result of making the execution request, the number of setting items (the number of scheduled imports) to be subjected to import processing among the setting items thus specified. When the OS of the operation unit 20 is Android (registered trademark), each of the applications in the operation unit 20 may use a method such as “sendBroadcast” for the returning.

Subsequently, each of the applications set as import destinations executes import processing in which to read out setting information thereon from a predetermined storage unit (for example, the HDD 14) or the like and set setting information with respect to each setting item as illustrated in the drawings such as FIG. 3A to FIG. 5. For example, when an import file has been stored in the HDD 14, it is preferable that each of the applications use the application ID and the item ID to identify and read out setting information thereon from setting information contained in the import file in the HDD 14.

The setting managing unit 112 in the main body unit 10 may divide (break down) the setting information contained in the import file into sets of setting information corresponding to the respective applications and store the sets of setting information in a storage unit or the like (for example, the HDD 14), or may divide only setting information on the operation unit applications into sets of setting information and store the sets of setting information in a storage unit (such as the flash memory 24) in the operation unit 20. Each of the operation unit applications can specify and read out a set of setting information on the application from the setting information stored in, for example, the flash memory 24.

The respective applications transmit import execution results to the transmitters of the import execution requests. For example, the copy application 121 transmits the execution result to the setting managing unit 112 in the main body unit 10 (Step S184). The setting application 231 and the launcher 232 transmit the execution results to the setting managing unit 214 in the operation unit 20 (Step S185 and Step S186).

Upon receiving the execution results from the respective applications in the operation unit 20, the setting managing unit 214 in the operation unit 20 unifies the execution results (import results) of the respective applications, and writes a resultant unified result into a storage unit (for example, the HDD 14) in the main body unit 10 (Step S187). The setting managing unit 214 in the operation unit 20 transmits an import result to the setting managing unit 112 in the main body unit 10 (Step S188). The import result is, for example, information indicating whether the import processing has been successful.

Upon receiving the execution result from the applications set as import destinations, the setting managing unit 112 in the main body unit 10 outputs, for example, to the requester of the import, an import result obtained by unifying the execution results of the respective applications (Step S189).

As described above, when the main body unit 10 is currently able to immediately execute import processing in response to an import request accepted from the outside, the setting managing unit 214 in the operation unit 20 notifies the setting managing unit 112 in the main body unit 10 of the import request. In addition, once the setting managing unit 112 in the main body unit 10 has identified any operation unit application in the operation unit 20 as an application set as an import destination, the application controlling unit 222 in the operation unit 20 subjects the operation unit application to import processing exclusively applicable to operation unit applications in the operation unit 20.

Flows of Individual Sets of Information in Import Processing

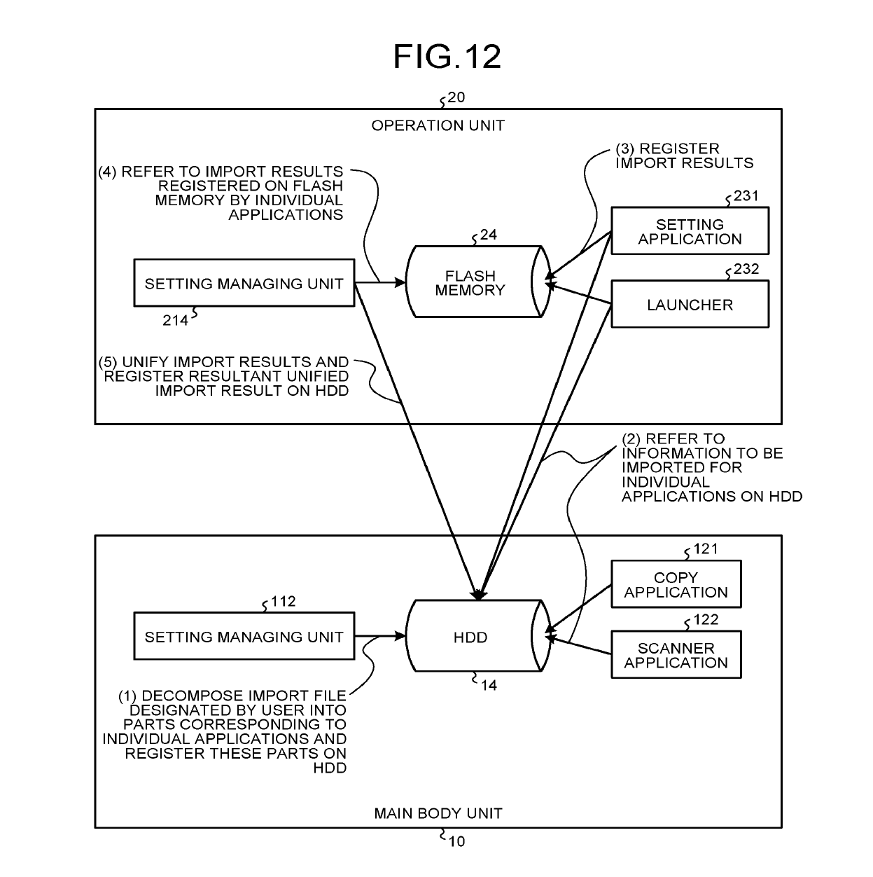

FIG. 12 is a diagram explaining flows of individual sets of information in import processing. The example in FIG. 12 represents an example in which the copy application 121, the scanner application 122, the setting application 231, and the launcher 232 have been designated as applications set as import destinations.

In the import processing illustrated in FIG. 12, the setting managing unit 112 in the main body unit 10 decomposes an import file specified by the user into parts corresponding to the respective applications, and registers the parts on the HDD 14 ((1) in FIG. 12).

The respective applications (the copy application 121, the scanner application 122, the setting application 231, and the launcher 232 in the example in FIG. 12) refer to the sets of information to be imported that are on the HDD 14 and for the respective applications ((2) in FIG. 12). For example, the respective operation unit applications (the setting application 231 and the launcher 232 in the example in FIG. 12) in the operation unit 20 execute import processing based on sets of the information to be imported to which the respective applications have referred, and register import results thereof on the flash memory 24 ((3) in FIG. 12).

The setting managing unit 214 in the operation unit 20 refers to the import results registered by the respective operation unit applications in the operation unit 20 ((4) in FIG. 12) to unify these import results, and then registers an import result of the entire operation unit 20 on the HDD 14 in the main body unit 10 ((5) in FIG. 12).

Sequence with Main Body Unit 10 being Unable to Immediately Execute Import Processing

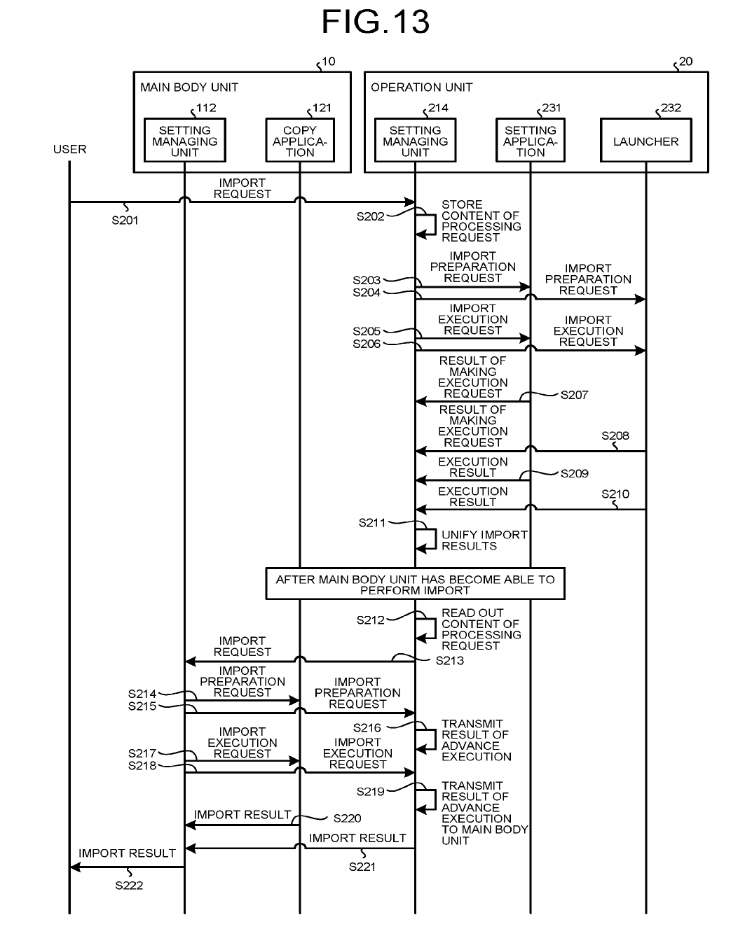

FIG. 13 is a sequence applicable when it is impossible for the main body unit to immediately execute import processing. The sequence illustrated in FIG. 13 is executed by: the setting managing unit 112 in the main body unit 10; the copy application 121, which is an exemplary main body unit application; the setting managing unit 214 in the operation unit 20; and the setting application 231 and the launcher 232, which are exemplary operation unit applications.

As illustrated in FIG. 13, the setting managing unit 214 in the operation unit 20 accepts an import request from the outside (such as the user, for example) through the accepting unit 220 (Step S201).

If the execution determining unit 221 has determined based on the operational status of the main body unit 10 that the main body unit 10 is currently unable to immediately execute import processing, the setting managing unit 214 in the operation unit 20 stores the import request (the content of requested processing) in the storage unit 213 (the flash memory 24) in the operation unit 20 (Step S202).

After this step, the setting managing unit 214 in the operation unit 20 causes the application controlling unit 222 to cause operation unit applications in the operation unit 20 to execute import processing.

That is, the setting managing unit 214 in the operation unit 20 causes the application controlling unit 222 to transmit import preparation requests and import execution requests to operation unit applications in the operation unit 20 (the setting application 231 and the launcher 232 in the example in FIG. 13) designated as import destinations (Step S203 to Step S206). The respective applications that have received the import execution requests transmit, to the transmitter of the import execution requests, results of making the execution requests (Step S207 and Step S208).

In addition, the respective applications (the setting application 231 and the launcher 232 in the example in FIG. 13) in the operation unit execute import processing and transmit results of import execution to the transmitter of the import execution requests (Step S209 and Step S210). Upon receiving the results of the execution from the respective applications in the operation unit 20, the setting managing unit 214 in the operation unit 20 reads out import results stored by the respective applications, unifies these import results, and writes a resultant unified import result into the flash memory 24 (Step S211).

After this step, if the execution determining unit 221 has determined based on the operational status of the main body unit 10 that the main body unit 10 has become able to execute import processing, the setting managing unit 214 in the operation unit 20 reads out the content of processing request stored in a storage such as the flash memory 24 in the processing at Step S202 (Step S212). The setting managing unit 214 in the operation unit 20 transmits an import request to the setting managing unit 112 in the main body unit 10 (Step S213).

As in the processing illustrated in FIG. 11 described above, the setting managing unit 112 in the main body unit 10 causes import processing to be executed, that is, transmits import preparation requests and import execution requests to applications (the copy application 121 and the setting managing unit 214 in the operation unit 20 in the example of FIG. 13) designated as import destinations (Step S214, Step S215, Step S217, and Step S218).

In response to the import preparation request from the setting managing unit 112 in the main body unit 10, the setting managing unit 214 in the operation unit 20 transmits a result of advance execution (Step S216). In response to the import execution request from the setting managing unit 112 in the main body unit 10, the setting managing unit 214 in the operation unit 20 acquires a result of the execution stored in advance from the flash memory 24, and writes the result of the execution into the storage unit 113 (for example, the HDD 14) in the main body unit 10 (Step S219). The application in the main body unit (the copy application 121 in the example in FIG. 13) transmits an import result to the setting managing unit 112 in the main body unit 10 (Step S220).

The setting managing unit 214 in the operation unit 20 then transmits an execution result of the writing processing (an import result) to the setting managing unit 112 in the main body unit 10 (Step S221). Upon receiving the execution results from the respective applications set as import destinations, the setting managing unit 112 in the main body unit 10 generates an import result, and outputs the import result as in the processing in FIG. 11 (Step S222).

As described above, when the main body unit 10 is currently unable to immediately execute import processing in response to an import request accepted from the outside, the application controlling unit 222 in the operation unit 20 causes an operation unit application to execute import processing in advance of the main body unit 10. The time to be taken for processing in the operation unit 20 after the main body unit 10 has become able to execute import processing can be reduced consequently, so that the time to be taken for completing import processing in the entire MFP 1 can be reduced.

Flow of Each Set of Information with Main Body Unit 10 being Unable to Immediately Execute Import Processing

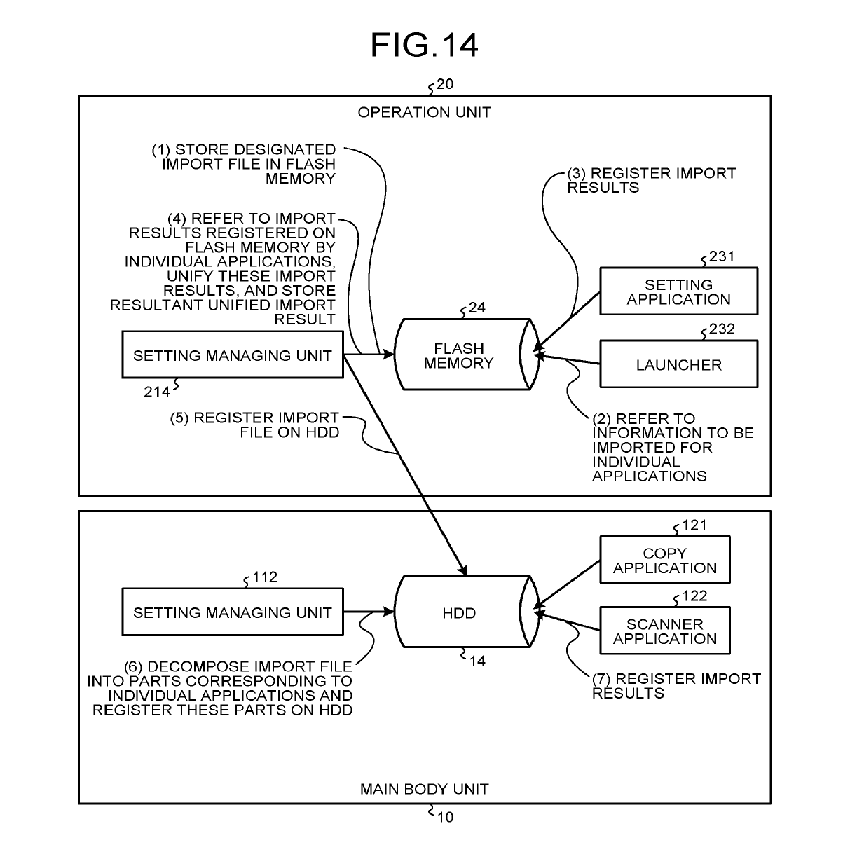

FIG. 14 is a diagram explaining flows of individual sets of information in a case when the main body unit is currently unable to immediately execute import processing. The example in FIG. 14 represents an example in which the copy application 121, the scanner application 122, the setting application 231, and the launcher 232 have been designated as import destinations.

In import processing illustrated in FIG. 14, the setting managing unit 214 in the operation unit 20 stores, in the flash memory 24, an import file (the content of an import request) designated by an outside party such as the user ((1) in FIG. 14).

The operation unit applications set as import destinations in the operation unit 20 refer to sets of information to be imported on the respective applications that have been stored in the flash memory 24 so as to execute import processing in advance ((2) in FIG. 14). The operation unit applications execute the import processing based on the sets of import information to which the respective applications have referred, and registers import results in the flash memory 24 ((3) in FIG. 14). The setting managing unit 214 in the operation unit 20 refer to the import results registered by the operation unit applications, unifies the import results, and then stores a resultant import result for the entire operation unit 20 in the flash memory 24 ((4) in FIG. 14).

Upon having determined that the main body unit 10 has become able to execute import processing, the setting managing unit 214 in the operation unit 20 registers, in the HDD 14 in the main body unit 10, the content of the import request (the import file) that has been stored in the flash memory 24 ((5) in FIG. 14). Consequently, import processing is started in the main body unit 10.

The setting managing unit 112 in the main body unit 10 breaks down an import file designated by the user into parts corresponding to the respective applications, and registers the parts in the HDD 14 ((6) in FIG. 14). The operation unit applications set as import destinations in the main body unit 10 execute the import processing based on sets of information to be imported that have been registered in the HDD 14, and registers import results ((7) in FIG. 14). Upon accepting an import request from the setting managing unit 112 in the main body unit 10, the setting managing unit 214 in the operation unit 20 acquires, from the flash memory 24, the import result for the entire operation unit 20 that has been generated in advance, and registers the import file on the HDD 14.

In the first embodiment, in the operation unit 20, the execution determining unit 221 acquires the operational status of the main body unit 10 when the accepting unit 220 accepts an export request or import request. Based on the operational status (such as being in the power saving mode or executing processing for which settings are unchangeable, for example) of the main body unit 10, the execution determining unit 221 determines whether the main body unit 10 is currently able to execute export processing or import processing. The communication unit 211 transmits an export request or import request to the main body unit 10 depending on the result of the determination from the execution determining unit 221. In a conventional technique, the main body unit is configured to accept an export request or import request. In this embodiment, the accepting unit 220 accepts an export request or import request first, and adjusts the timing to transfer the request to the main body unit 10. Consequently, the main body unit 10 is enabled to receive an export request or import request when being in a state able to execute export processing or import processing. Inefficiency such as putting the main body unit 10 in a situation of being unable to receive an export request or import request can thus be eliminated. Consequently, Export processing and import processing for setting information can thus be efficiently executed.

In addition, when the main body unit 10 is temporarily unable to execute export processing or import processing, the application controlling unit 222 causes an operation unit application to execute export processing or import processing in advance in the operation unit 20. The setting managing unit 214 acquires the processing result of export processing or import processing before the main body unit 10 becomes able to execute processing. Therefore, in order to execute the processing, the setting managing unit 214 does not need to wait until it accepts the request from the main body unit 10. Consequently, after the main body unit 10 becomes able to execute processing in, the setting managing unit 214 does not need to execute the export processing or import processing, and the time to be taken for processing in the operation unit 20 can thus be reduced. The time to be taken for completing processing in the entire MFP 1 can thus be reduced.

### Second Embodiment

Next, a second embodiment is described. Some of the foregoing applications set as import destinations may be, depending on what kinds of applications they are, subject to various conditions in order to become usable with imported settings reflected. For example, there are an application that becomes usable after individual settings are immediately reflected therein, and an application that becomes usable after setting is reflected therein following a certain time period for restart or the like during which the MFP 1 is set unusable.

For example, operation unit applications in the operation unit 20 include an application that becomes usable after settings are reflected through processing only in the operation unit 20; and an application that becomes usable after settings are reflected through processing in the operation unit 20 and processing in the main body unit 10 that are linked with each other. Given this situation, the second embodiment describes processing through which, after import processing for operation unit applications, settings for functions that are provided when the respective operation unit applications are executed are reflected based on conditions set with respect to each of the functions.

### Exemplary Functional Blocks in Operation Unit in Second Embodiment

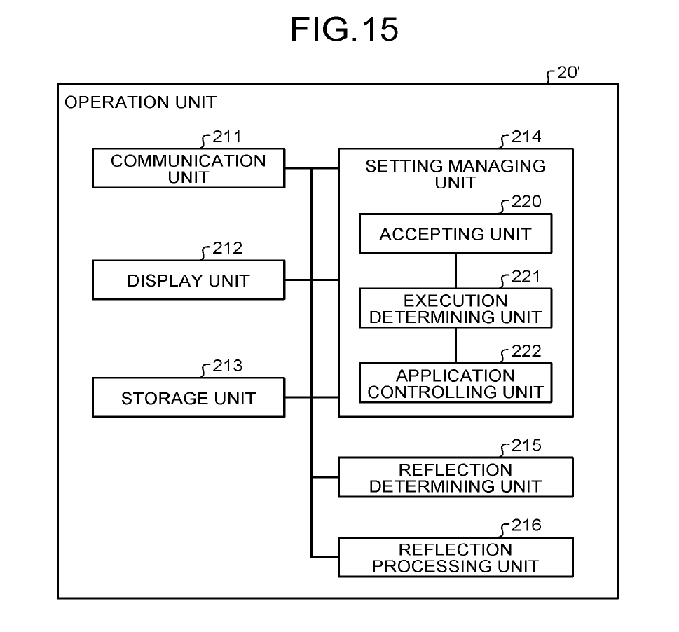

A second embodiment is different from the first embodiment in configuration inside the operation unit 20 among the functional blocks of the MFP 1 illustrated in FIG. 2. For this reason, the following describes exemplary functional blocks in an operation unit in the second embodiment. FIG. 15 is a diagram illustrating exemplary functional blocks in an operation unit in the second embodiment. The same reference signs are assigned to the same components in the operation unit 20′ illustrated in FIG. 15 as those in the operation unit 20 in the first embodiment described above, and specific description thereof is omitted herein.

The operation unit 20′ illustrated in FIG. 15 includes the communication unit 211, the display unit 212, the storage unit 213, the setting managing unit 214, a reflection determining unit 215, and the reflection processing unit 216, each of which is a function (module) when the CPU 21 runs a computer program. Each of some of the above units may be software (a computer program) that causes the corresponding one of the above units to be loaded onto the RAM 23 and generated on the RAM 23 when the CPU 21 reads out and executes the software (the computer program) from the ROM 22 or the flash memory 24. In addition, some of the above units may be replaced with hardware circuitry such as a processor that performs arithmetic processing corresponding thereto.

The reflection determining unit 215 is implemented when the CPU 21 executes instructions read out thereby from the ROM 22. The reflection determining unit 215 determines, for example, based on conditions (import reflection conditions) set with respect each of the functions for which the operation unit applications are executed, whether an imported result (setting information) can be reflected in each function to be provided by the operation unit applications after import processing. The import reflection conditions have been stored in a storage such as the storage unit 213.

For example, when it is necessary to use any function in the main body unit 10 to reflect setting information, the reflection determining unit 215 further determines, based on the relation between the operational status of the main body unit 10 and each target function, whether the function in the main body unit 10 is usable. Optionally, when the function in the main body unit 10 is unusable based on the operational status of the main body unit 10, the reflection determining unit 215 may inquire of a user about whether to change the operational status of the main body unit 10 from the current state to another.

The reflection processing unit 216 is implemented when the CPU 21 executes instructions read out thereby from the ROM 22. If the reflection determining unit 215 has determined that setting information can be reflected after import processing, the reflection processing unit 216 executes reflection of setting information in a function to be provided. If the reflection determining unit 215 has determined that setting information cannot be reflected after import processing, the reflection processing unit 216 only conducts preparation for reflecting setting information and later executes the reflection after reflection of setting information has become possible, for example. The preparation for reflecting setting information includes, but not limited to, for example, converting the setting information into a format type or a file format corresponding to an application set as an import destination.

Conditions for Import Reflection

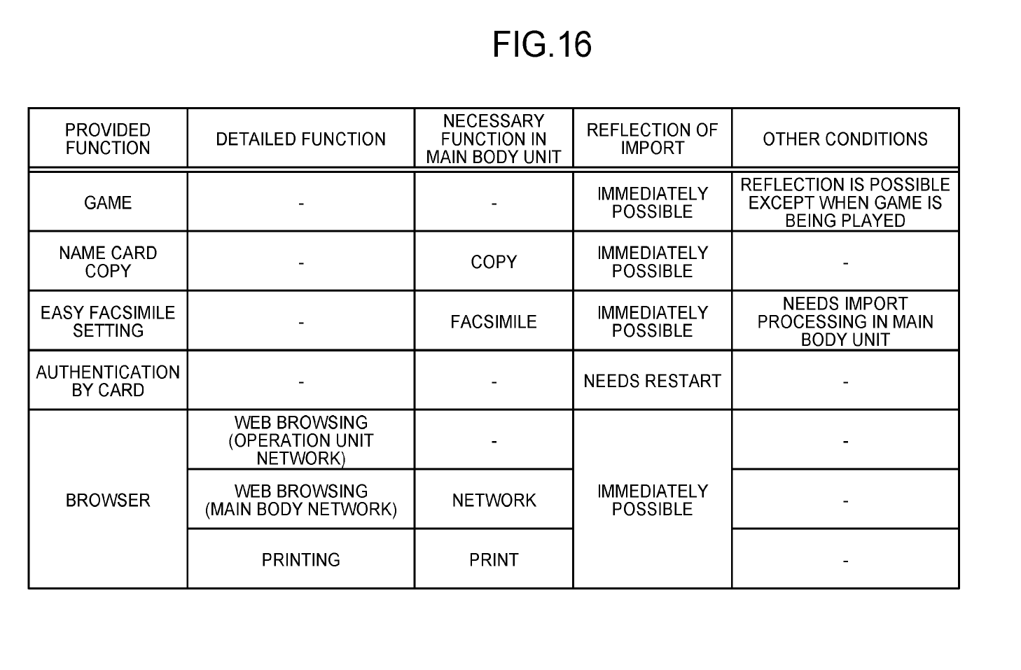

FIG. 16 is a diagram illustrating exemplary conditions for import reflection in the second embodiment. The example in FIG. 16 uses, for example, items such as “provided functions”, “detailed functions”, “necessary functions in the main body unit”, “reflection of import”, and “other conditions” to explain conditions for reflecting import for functions to be provided when individual operation unit applications are executed.

For example, the “provided functions” mean functions to be provided when the operation unit applications are executed. Examples of such a function include, but are not limited to, “game”, “name card copy”, “easy facsimile setting”, “authentication by card”, and “browser”.

The “detailed functions” mean functions into which each of the “provided functions” is broken down. For example, the “browser” function is broken down into detailed functions that are a web browsing function through the operation unit 20 and a web browsing function through the main body unit 10.

The “necessary functions in the main body unit” mean functions on the main body unit 10 side that are needed for the respective “provided functions” to operate. The “reflection of import” means information such as whether setting information can be reflected in each of the “provided functions” after import processing, and whether the reflection needs any condition (for example, restart). The “other conditions” means information such as the timing when setting information is reflected after import processing, and whether the main body unit 10, the operation unit 20′, or the like is needed to execute import processing.

For example, the “game” among the “provided functions” illustrated in FIG. 16 operates only by use of a function in the operation unit 20′. In contrast, the “name card copy” and the “easy facsimile setting” operate by use of the “copy” and the “facsimile” functions, respectively, in the main body unit 10. The “browser” among the “provided functions” illustrated in FIG. 16 is broken down into detailed functions such as the “web browsing” and “printing”, operates using the “network” function in the main body unit 10 for the “web browsing (main body network)” and using the “print” in the main body unit 10 for the “printing”.

In addition, the “reflection of import” is immediately possible for functions such as the “game” and the “name card copy” among the “provided functions” illustrated in FIG. 16. In contrast, the MFP 1 needs to be restarted (rebooted) one time for the “reflection of import” for functions such as the “authentication by card”.

Furthermore, the “easy facsimile setting” among the “provided functions” illustrated in FIG. 16 is updated only after import processing is executed on facsimile settings in the main body unit 10. As described above, some of the functions need import processing both in the operation unit 20′ and in the main body unit 10.

In the second embodiment, with respect to each function to be provided when a corresponding operation unit application is executed, import reflection conditions as illustrated in FIG. 16 are previously set and stored in a storage such as the storage unit 213 in the operation unit 20′. Based on the import reflection conditions, the reflection determining unit 215 in the operation unit 20′ determines whether an import result can be reflected in the function to be provided by the operation unit application after import processing. The example in FIG. 16 does not limit the contents of import reflection conditions.

Exemplary Conditions Corresponding to Operational Status of Main Body Unit 10 for Determining Whether Target Functions are Usable

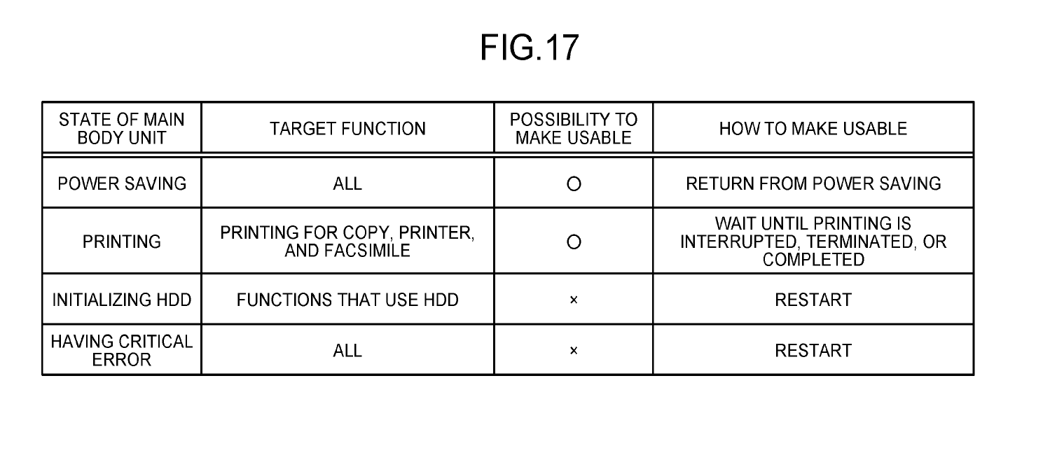

FIG. 17 is a diagram illustrating conditions corresponding to the operational status of the main body unit for determining whether each target function is usable. The example in FIG. 17 include exemplary items such as “states of the main body unit”, “target functions”, “possibility to make the functions usable”, and “how to make the functions usable”; however, items are not limited to this example.

The “states of the main body unit” illustrated in FIG. 17 mean states in which the operational status the main body unit 10 is in (contents of execution performed by the main body unit 10) when the “target functions” that the main body unit 10 has are unusable. The “states of the main body unit” include for example, but are not limited to, “power saving”, “printing”, “initializing HDD”, and “having a critical error”.

The example in FIG. 17 indicates that, when the main body unit 10 is in a “power saving” state, all of the “target functions” that the main body unit 10 has become usable in response to “return from the power saving state (having the MFP 1 returned to a normal state (the normal mode))”. The example also indicates that, when the main body unit 10 is in a “printing” state, a function such as “printing for copy, printer and facsimile” that the main body unit 10 has become usable when a user selects a manner such as to “wait until printing is interrupted, terminated, or completed”.

The example also indicates that; when the main body unit 10 is in a state “initializing a HDD” or “having a critical error”, the user will not be able to continue the using unless the current status changes; and “restarting the MFP 1” makes functions using the HDD or all functions usable.

As described above, conditions corresponding to the operational status of the main body unit 10 for determining whether each target function is usable, as illustrated in FIG. 17, are previously set and stored in a storage such as a storage unit 213 in the operation unit 20′. Based on these conditions corresponding to the operational status of the main body unit 10 for determining whether each target function is usable, the reflection determining unit 215 in the operation unit 20′ determines whether each function in the main body unit 10 is immediately usable. The example in FIG. 17 does not limit the contents of the conditions for determining whether each target function is usable.

Import Reflection Processing

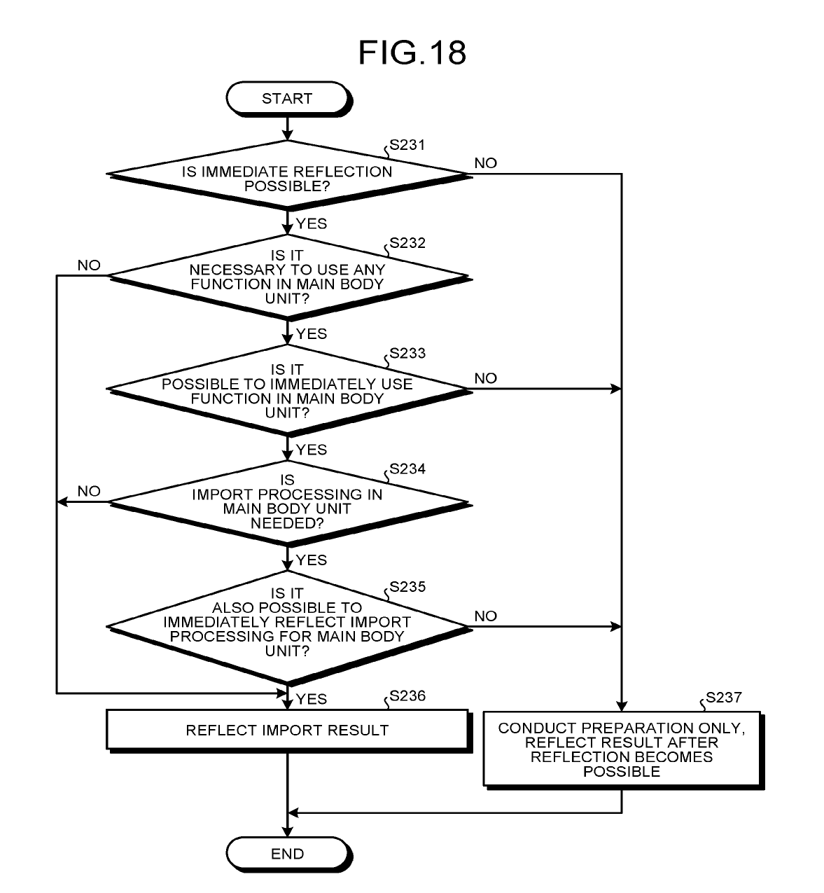

FIG. 18 is a flowchart illustrating import reflection processing in the second embodiment. In the example in FIG. 18, the reflection determining unit 215 in the operation unit 20′ determines, based on import reflection conditions previously set for a function to be provided by an operation unit application for which import processing has been executed, whether a result of importing (imported setting information) can be immediately reflected in the function (Step S231).

Upon having determined that the result of importing can be immediately reflected (Yes at Step S231), the reflection determining unit 215 in the operation unit 20′ determines, based on the previously set import reflection conditions, whether it is necessary to use any function in the main body unit 10 (Step S232). Upon having determined that it is necessary to use any function in the main body unit 10 (Yes at Step S232), The reflection determining unit 215 in the operation unit 20′, based on previously set conditions corresponding to the operational status of the main body unit 10 for determining whether each target function is usable, whether the function in the main body unit 10 is immediately usable (Step S233).

Upon having determined that the function in the main body unit 10 is immediately usable (Yes at Step S233), the reflection determining unit 215 in the operation unit 20′ determines, based on the previously set import reflection conditions, whether import processing in the main body unit 10 is needed (Step S234). Upon having determined that import processing in the main body unit 10 is needed (Yes at Step S234), the reflection determining unit 215 in the operation unit 20′ determines whether immediate reflection of the import processing in the main body unit 10 is also possible (Step S235).

In processing at Step S235, the reflection determining unit 215 in the operation unit 20′ can base the determination on a result of the above-described determination made by the execution determining unit 221 in the operation unit 20′ in processing at Step S102 in FIG. 6 as to whether the main body unit 10 is currently able to immediately execute import processing. For example, if the execution determining unit 221 in the operation unit 20′ has determined that the main body unit 10 is currently able to immediately execute import processing, the reflection determining unit 215 in the operation unit 20′ can also determine that immediate reflection of the import processing in the main body unit 10 is possible.

Upon having determined that immediate reflection of the import processing in the main body unit 10 is also possible (Yes at Step S235), the reflection determining unit 215 in the operation unit 20′, upon having determined in processing at Step S232 that it is not necessary to use any function in the main body unit 10 (No at Step S232), or of having determined in processing at Step S234 that import to the main body unit 10 is not needed (No at Step S234), the reflection processing unit 216 in the operation unit 20′ reflects an import result (Step S236).

Otherwise, if the reflection determining unit 215 in the operation unit 20′ has determined in processing at Step S231 that immediate reflection of the import processing in the main body unit 10 is impossible (No at Step S231), if it has determined in processing at Step S233 that the main body unit 10 is not immediately usable (No at Step S233), or if it has determined in processing at Step S235 that the import processing in the main body unit 10 is also impossible (No at Step S235), the reflection processing unit 216 in the operation unit 20′ conducts only preparation and reflects an import result after the reflection has become possible (Step S237), and ends processing.

As described above, when it is impossible to immediately reflect an import result in a function to be provided by an operation unit application for which import processing has been executed, the results are reflected after all necessary conditions are met. In contrast, when it is possible to immediately reflect an import result because, for example, the reflection is possible only through processing on the part of the operation unit 20′, the function in which imported settings have been reflected is immediately provided.

Processing Example in Case Using Function in Main Body Unit 10

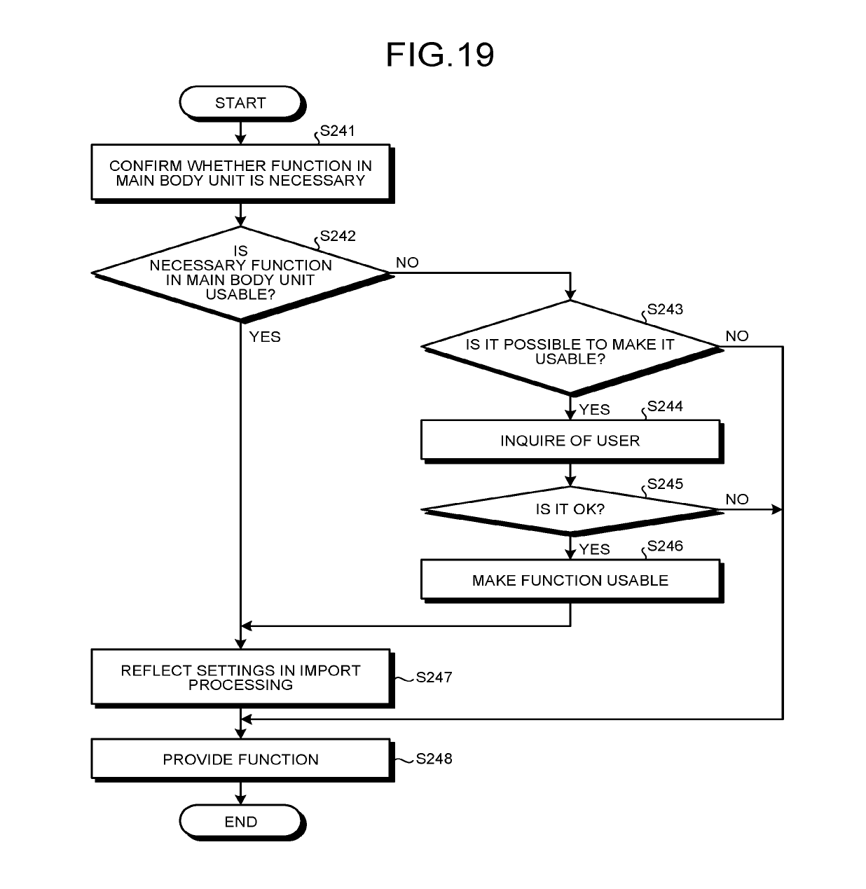

Next described is a specific example of a case in which, in the foregoing processing at Step S232 in FIG. 18, it is determined to be necessary to use any function in the main body unit 10. FIG. 19 is a flowchart applicable when a function in the main body unit is to be used.

In the example in FIG. 19, the reflection determining unit 215 in the operation unit 20′ confirms whether it is necessary to use any function in the main body unit for a function to be provided by an operation unit application for which import processing has been executed (Step S241). Upon confirmed that it is necessary to use any function in the main body unit 10, the reflection determining unit 215 in the operation unit 20′ determines, based on previously set conditions corresponding to the operational status of the main body unit 10 for determining whether each target function is usable, whether the necessary function in the main body unit 10 is usable (Step S242).

Upon having determined that the necessary function in the main body unit 10 is unusable (No at Step S242), the reflection determining unit 215 in the operation unit 20′ determines whether the function can be made usable by, for example, changing the operational status of the main body unit 10 (for example, changing the status from “printing” to “printing terminated”) (Step S243).

Upon having determined that the function can be made usable (Yes at Step S243), the reflection determining unit 215 in the operation unit 20′ inquires of the user about whether to make the necessary function in the main body unit 10 usable by, for example, changing the operational status of the main body unit 10 (Step S244).

The reflection determining unit 215 in the operation unit 20′ determines whether it is OK with the user as a result of the inquiry (for example, as to whether the user allows the status to be changed from “printing” to “printing terminated”) (Step S245). Upon having determined that it is OK with the user as a result of the inquiry (Yes at Step S245), the reflection determining unit 215 in the operation unit 20′ makes the necessary function in the main body unit 10 usable by, for example, the operational status of the main body unit 10 (Step S246).

Otherwise, if the reflection determining unit 215 in the operation unit 20′ has determined in processing at Step S242 that the necessary function in the main body unit 10 is usable (Yes at Step S242), or after the processing at Step S246, the reflection processing unit 216 in the operation unit 20′ reflects settings in import processing (an import result) (Step S247). Consequently, the operation unit 20 provides the function in which imported settings have been reflected (Step S248).

Otherwise, if the reflection determining unit 215 in the operation unit 20′ has determined in processing at Step S243 that it is impossible to make the necessary function in the main body unit 10 usable (No at Step S243), or if it has determined in processing at Step S245 that it is not OK with the user as a result of the inquiry (No at Step S245), the operation unit 20′ provides the function without reflecting the imported settings therein (Step S248), and ends processing.

As described above, a first function, among functions to be provided when operation unit applications are executed, that needs to use any function in the main body unit 10 is provided to the user with settings in import processing reflected in the first function, on condition that the function in the main body unit 10 has been determined to be usable before the provision of the first function.

Flowchart of Entire Import Processing for Reflecting Settings

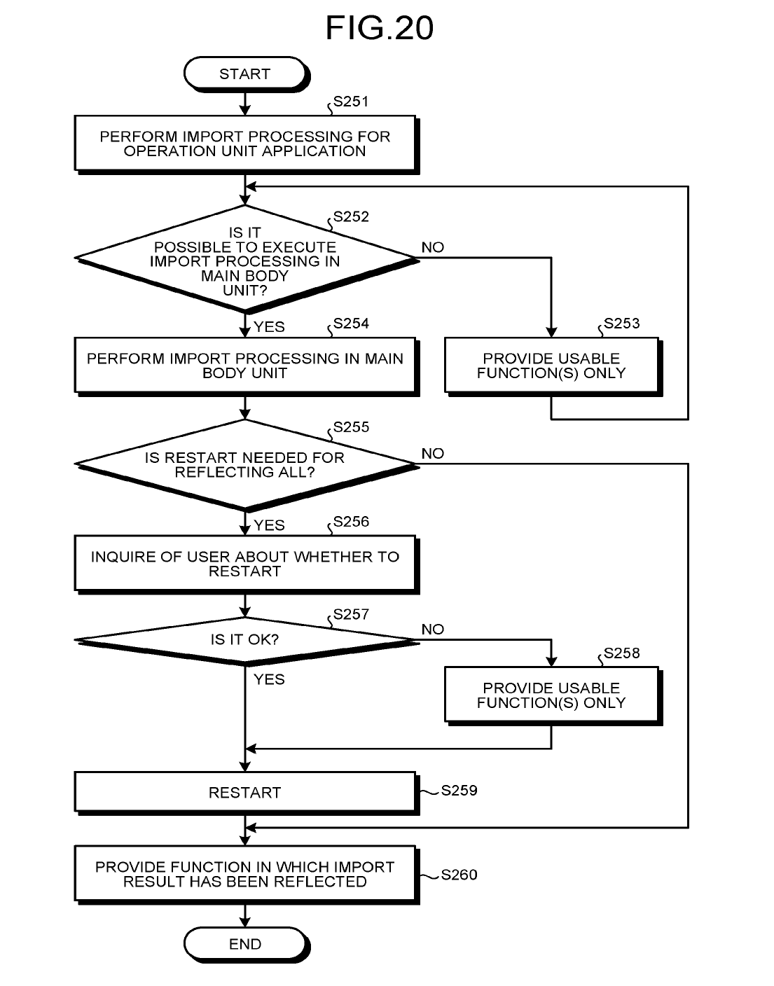

Next described is the entire import processing in the operation unit 20′ and the main body unit 10 for reflecting import results based on the foregoing processing in FIG. 18 and FIG. 19. FIG. 20 is a flowchart for the entire import processing in the operation unit and the main body unit.

In the example in FIG. 20, the setting managing unit 214 in the operation unit 20′ performs import processing for operation unit applications (Step S251), and the execution determining unit 221 in the operation unit 20′ determines, based on the operational status of the main body unit 10, whether the main body unit 10 is currently able to execute import processing (Step S252).

If the execution determining unit 221 has determined that the main body unit 10 is currently unable to execute import processing (No at Step S252), the setting managing unit 214 in the operation unit 20′ provides only each usable function in which an import result has been reflected based on the foregoing processing in FIG. 18 and FIG. 19 (Step S253), and the procedure returns to the processing at Step S252.

Otherwise, if the setting managing unit 214 in the operation unit 20′ has determined that the execution determining unit 221 has determined that the main body unit 10 is currently able to execute import processing (Yes at Step S252), the setting managing unit 112 in the main body unit 10 performs import processing in the main body unit 10 based on notification from the setting managing unit 214 in the operation unit 20′ (Step S254).

The setting managing unit 214 in the operation unit 20′ determines, based on certain conditions previously set, whether restart is needed for completing all import processing (Step S255). Upon having determined that restart is needed (Yes at Step S255), the setting managing unit 214 in the operation unit 20′ inquires of the user about whether restart is OK (Step S256).

The setting managing unit 214 in the operation unit 20′ determines whether it is OK with the user as a result of the inquiry (Step S257). Upon having determined that it is not OK with the user as a result of the inquiry (No at Step S257), the setting managing unit 214 in the operation unit 20′ provides only each usable function (Step S258).

Upon having determined that it is OK with the user as a result of the inquiry (Yes at Step S257), or after the processing at Step S258, the setting managing unit 214 in the operation unit 20′ performs restart (Step S259).

After the restart at Step S259, or upon having determined in processing at Step S255 that restart is not needed for completing all import processing (No at Step S255), the setting managing unit 214 in the operation unit 20′ provides each function that has an import result reflected therein (Step S260), and ends processing.

After import processing, the setting managing unit 214 in the operation unit 20′ provides functions in which import results have been reflected as much as possible based on the foregoing processing in FIG. 18 and FIG. 19. When the main body unit 10 is currently unable to execute import processing, the setting managing unit 214 in the operation unit 20′ reflects imported settings in each function that can be provided without any further processing performed other than processing within the operation unit 20′, and then provides the function. In addition, when the main body unit 10 has become able to execute import processing, the setting managing unit 214 in the operation unit 20′ causes suspended import processing in the main body unit 10 to be executed.

Note that, when current use needs to be temporarily interrupted for restart or the like so that all import processing can be completed, the user or the like may be enabled to select between: performing such processing; and providing only each currently usable function to later perform such processing as restart.

Procedure of Processing to be Performed in Providing Usable Function(s)

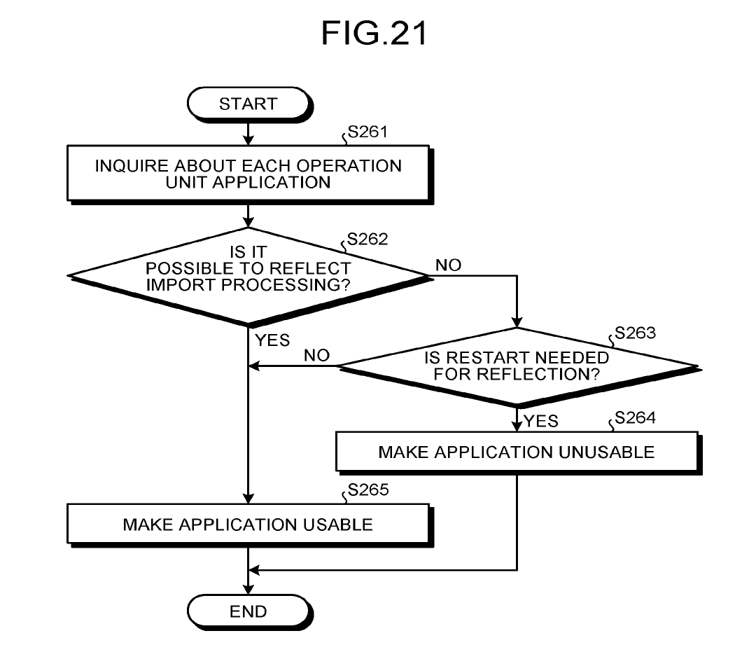

Next described is processing to be performed in providing each usable function in processing at Step S253 in FIG. 20. FIG. 21 is a flowchart for processing for providing each usable function. In the example in FIG. 21, the setting managing unit 214 in the operation unit 20′ inquires of the reflection determining unit 215 about each operation unit application (Step S261), and determines with respect to each operation unit application whether it is possible to reflect an import result (Step S262).

Upon having determined that it is impossible to reflect import processing (No at Step S262), the setting managing unit 214 in the operation unit 20′ determines, with reference to conditions such as FIG. 16 and FIG. 17, whether restarting the MFP 1 is needed for reflection of import processing on the basis of the operational status of the MFP 1, for example (Step S263). Upon having determined that restarting the MFP 1 is needed (Yes at Step S263), the setting managing unit 214 in the operation unit 20′ makes any operation unit application for which the restart is needed unusable (notifies through the operation panel that the operation unit application is unusable) (Step S264).

Otherwise, upon having determined that it is possible to reflect import processing (Yes at Step S262), or upon having determined in processing at Step S263 that restarting the MFP 1 is not needed (No at Step S263), the setting managing unit 214 in the operation unit 20′ makes such an operation unit application usable (Step S265), and ends processing. Consequently, functions currently able to be provided and functions currently unable to be provided can be provided to the user.

In the second embodiment, after import processing for operation unit applications in the operation unit 20′, settings for functions to be provided when the respective operation unit applications are executed are previously reflected based on conditions set with respect to each of the functions. Consequently, even before execution of import processing for the entire MFP including the main body unit becomes possible, settings can be reflected at least in a usable function. Thus, it is made possible to provide to a user, before import processing for the entire MFP is completed, a function or functions in each of which the most updated setting information has been reflected within the operation unit 20′.

The first embodiment and second embodiment described above enable efficient execution of input/output processing for setting information.

Note that a computer program to be executed in an apparatus (image forming apparatus) in each of these embodiments is previously embedded in a ROM or the like and provided. A computer program to be executed in the apparatus in each of these embodiments may be recorded as an installable or executable file in a computer-readable recording medium such as a compact disc read only memory (CD-ROM), a flexible disk (FD), a compact disc recordable (CD-R), and a digital versatile disc (DVD) and provided as a computer program product.

A computer program to be executed in the apparatus in each of these embodiments may be stored on a computer connected to a network such as the Internet and provided by being downloaded via the network. A computer program to be executed in the apparatus in each of these embodiments may be provided or distributed via a network such as the Internet.

A computer program to be executed in the apparatus in each of these embodiments is modules including the units described above. As actual hardware, the CPU (processor) reads out the computer program from the above ROM and executes the programs, and the above units are thereby loaded onto a main memory and generated thereon. Some or all of the functions of the foregoing units may be implemented by a dedicated hardware circuit.

Exemplary embodiments of the present invention thus enable efficient execution of input/output processing for setting information.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
a first unit configured to accept operational input; and
a second unit configured to operate in response to the operational input,
the first unit including:
an accepting unit configured to accept an input or output request for setting information on an application that operates in the first unit or the second unit;
an execution determining unit configured to acquire an operational status of the second unit and, based on the acquired operational status, determine whether the second unit is currently able to execute input or output processing corresponding to the input or output request received by the accepting unit; and
a communication unit configured to transmit the input or output request for the setting information to the second unit depending on a result of the determination by the execution determining unit, and
the second unit including:
a setting managing unit configured to, in response to the input or output request received from the communication unit, cause input or output processing for the setting information to be executed.

2. The information processing system according to claim 1, further comprising:
an application controlling unit configured to, when the execution determining unit has determined that the second unit is currently unable to execute input or output processing, cause an application that operates in the first unit to execute processing corresponding to the input or output request for the setting information.

3. The information processing system according to claim 1, wherein
the first unit further includes:
a reflection determining unit configured to determine, based on conditions set with respect to each function among functions to be provided when at least one first unit application is executed, whether it is possible to reflect the setting information in the function to be provided, the first unit application being an application that operates in the first unit; and
a reflection processing unit configured to, when the reflection determining unit has determined that it is possible to reflect the setting information, reflect the setting information in the function to be provided.

4. The information processing system according to claim 3, wherein
when the function to be provided uses any function in the second unit, the reflection determining unit determines, based on a relation between a current operational status of the second unit and the function in the second unit to be used, whether the function in the second unit to be used is usable, and
when the reflection determining unit has determined that the function in the second unit to be used is usable, the reflection processing unit reflects the setting information in the function to be provided.

5. The information processing system according to claim 4, wherein,
upon having determined that the function in the second unit to be used is unusable, the reflection determining unit inquires about whether to change the operational status of the second unit, and changes the operational status of the second unit depending on a result of the inquiry.

6. The information processing system according to claim 3, wherein
the first unit makes a corresponding one of the at least one first unit application unusable when it is necessary to change the operational status of the second unit.

7. The information processing system according to claim 1, wherein
the first unit is an operation unit in an image forming apparatus, and
the second unit is a main body unit in the image forming apparatus.

8. An information processing method to be executed in an information processing system that comprises a first unit configured to accept operational input and a second unit configured to operate in response to the operational input, the information processing method comprising:
accepting an input or output request for setting information on an application that operates in the first unit or the second unit;
based on an operational status of the second unit, determining whether the second unit is currently able to execute input or output processing corresponding to the input or output request received at the accepting;
transmitting the input or output request for the setting information to the second unit depending on a result of the determining; and
in response to the input or output request transmitted at the transmitting, causing input or output processing for the setting information to be executed.

9. An information processing system comprising:
a first unit that accepts operational input; and
a second unit that operates in response to the operational input,
the first unit including first circuitry configured to:
accept an input or output request for setting information on an application that operates in the first unit or the second unit;
acquire an operational status of the second unit and, based on the acquired operational status;
determine whether the second unit is currently able to execute input or output processing corresponding to the input or output request accepted; and
transmit the input or output request for the setting information to the second unit depending on a result of the determination by the execution determining unit, and
the second unit including second circuitry configured to:
cause input or output processing for the setting information to be executed, in response to the input or output request received from the communication unit.

10. The information processing system according to claim 9, wherein
the first circuitry and the second circuitry respectively include a processor and a memory.
